(19) United States
(12) Patent Application Publication
(10) Pub. No.: US 2026/0331088 A1
(43) Pub. Date: Oct. 22, 2026

(54) WI-FI KARAOKE ENTERTAINMENT-HUB WITH DETACHABLE TOUCHSCREEN

(71) Applicant: Arts Digital Technology (HK) Ltd., Shatin (HK)

(72) Inventor: KAR- CHI NG, Shatin (HK)

(21) Appl. No.: 19/234,995

(22) Filed: Jun. 11, 2025

Related U.S. Application Data
(60) Provisional application No. 63/658,987, filed on Jun. 12, 2024.
(60) Provisional application No. 63/748,632, filed on Jan. 23, 2025.

(51) Int. Cl. G10H 1/36; G10H 1/00; H04R 1/02

(52) U.S. Cl. CPC G10H 1/368; G10H 1/0008; H04R 1/023

(57) ABSTRACT

A multifunctional sound bar system is disclosed that integrates audio, visual, and user interface components within a tubular housing. The system includes a processor configured to coordinate system operations, a plurality of integrated speakers positioned to emit audio through speaker grills located on the front and end surfaces of the housing, and a centrally positioned touchscreen display configured to present a graphical user interface and receive user input. A control panel disposed on the top surface of the housing includes tactile interface elements for system control. The system further includes a network interface for accessing external multimedia content, and may include additional features such as wireless connectivity, microphone inputs, lighting effects, multimedia playback, and external display output. The integrated design provides an interactive and portable entertainment platform for karaoke, music playback, and audiovisual presentations.

### CROSS-REFERENCE TO RELATED APPLICATIONS

This application claims priority to U.S. Provisional Patent Application No. 63/658,987, filed on Jun. 12, 2024, and U.S. Provisional Patent Application No. 63/748,632, filed on Jan. 23, 2025, the disclosures of which are incorporated herein by reference in their entireties.

### BACKGROUND

Home entertainment systems often include audio and video components such as sound bars, streaming devices, and interactive platforms designed to enhance the user experience. These systems may incorporate features such as wireless connectivity, touchscreen displays, and multifunctional control interfaces to support music playback, video streaming, and user interaction. However, conventional configurations can be limited in integration, flexibility, or ease of use. The present application relates generally to entertainment systems that combine audio functionality with configurable touchscreen interfaces to support a variety of multimedia applications.

### SUMMARY

Embodiments of the present disclosure are directed to a multifunctional sound bar system comprising a housing with integrated speakers, a processor configured to coordinate system operations, and a touchscreen display for presenting a graphical user interface and receiving user input. The touchscreen display may be pivotally or fixedly mounted and can transition between a stowed and deployed position in certain embodiments. A control panel comprising tactile interface elements provides additional system controls. The system further includes a network interface for establishing wired or wireless connectivity to access external multimedia content. Some embodiments also include features such as synchronized lighting effects, microphone inputs, HDMI and auxiliary connections, and storage and playback capabilities via USB ports, enabling interactive use cases such as karaoke and multimedia presentations.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 is an architecture diagram depicting a karaoke system including at least a hub and a detachable console screen.

FIG. 2 is a front profile view depicting a karaoke system including a hub, detachable console screen, and microphone in accordance with a first embodiment of the disclosure.

FIG. 3 is a rear profile view depicting the karaoke system of FIG. 2.

FIG. 4 is a block diagram depicting computing modules of the hub of FIG. 1.

FIG. 5 is a block diagram depicting computing modules of the detachable console screen of FIG. 1.

FIG. 6 is a block diagram illustrating a multifunctional sound bar system, in accordance with an embodiment of the disclosure.

FIG. 7 is a front perspective view illustrating a multifunctional sound bar system, in accordance with an embodiment of the disclosure.

FIG. 8 is a front perspective view illustrating the multifunctional sound bar system of FIG. 7, in which a touchscreen display of the multifunctional sound bar system is in a stowed position, in accordance with an embodiment of the disclosure.

FIG. 9 is a front perspective view illustrating the multifunctional sound bar system of FIG. 8, with the touchscreen display in a deployed position, in accordance with an embodiment of the disclosure.

FIG. 10 is a partial, perspective view of the multifunctional sound bar system of FIG. 7, with the touchscreen display in a deployed position, in accordance with an embodiment of the disclosure.

FIG. 11 is a partial, perspective view of the multifunctional sound bar system of FIG. 10, with the touchscreen display in a stowed position, in accordance with an embodiment of the disclosure.

FIG. 12 is a partial, close-up view of a control panel of the multifunctional sound bar system of FIG. 7.

FIG. 13 is a partial, close-up view of electrical and optical inputs and outputs for the multifunctional sound bar system of FIG. 7.

FIG. 14 is a front perspective view illustrating a multifunctional sound bar system in accordance with an alternative embodiment of the disclosure.

FIG. 15 is an alternate perspective view illustrating the multifunctional sound bar system of FIG. 14.

FIG. 16 is a rear perspective view illustrating the multifunctional sound bar system of FIG. 14.

FIG. 17 is a partial, close-up view of the handle of FIG. 16.

FIG. 18 is a top view of the multifunctional sound bar system of FIG. 14.

FIG. 19 is a partial, close-up of the control panel of FIG. 18.

FIG. 20 is a rear view of the multifunctional sound bar system of FIG. 14.

FIG. 21 is a partial, close-up view of electrical and optical inputs and outputs for the multifunctional sound bar system of FIG. 14.

FIG. 22 is a block diagram illustrating components of a processor included in the multifunctional sound bar system of FIG. 6.

FIG. 23 is a hardware architecture diagram depicting a processor of the system depicted in FIG. 1 or 6.

FIG. 24 is a front perspective view depicting a karaoke system in accordance with the second embodiment of the disclosure.

FIG. 25 is an alternative front perspective view depicting the karaoke system of FIG. 24.

FIG. 26 is a rear perspective view depicting the karaoke system of FIG. 24.

FIG. 27 is a front perspective view depicting a karaoke system in accordance with a third embodiment of the disclosure.

FIG. 28 is an alternate front perspective view depicting the karaoke system of FIG. 27.

FIG. 29 is a front perspective view depicting a karaoke system in accordance with a fourth embodiment of the disclosure.

FIG. 30 is an alternate perspective view depicting the karaoke system of FIG. 29.

FIG. 31 is a rear perspective view depicting the karaoke system of FIG. 29.

FIG. 32 is a front perspective view depicting a karaoke system in accordance with a fifth embodiment of the disclosure.

FIG. 33 is an alternate perspective view depicting the karaoke system of FIG. 32.

FIG. 34 is a rear perspective view depicting the karaoke system of FIG. 32.

FIG. 35 is a first home screen displayable by the karaoke system of FIGS. 1-5 and 24-34 and the multifunctional sound bar system of FIGS. 5-22.

FIG. 36 is a second home screen displayable by the karaoke system of FIGS. 1-5 and 24-34 and the multifunctional sound bar system of FIGS. 5-22.

FIG. 37 is a third home screen displayable by the karaoke system of FIGS. 1-5 and 24-34 and the multifunctional sound bar system of FIGS. 5-22.

FIG. 38 is a fourth home screen displayable by the karaoke system of FIGS. 1-5 and 24-34 and the multifunctional sound bar system of FIGS. 5-22.

### DETAILED DESCRIPTION

The present disclosure relates to interactive audio-visual entertainment systems that integrate audio playback, visual display, user interaction, and wireless communication capabilities within a unified platform. In various embodiments, the system can include a multifunctional sound bar or a karaoke hub, optionally incorporating a detachable or foldable touchscreen display operable through a graphical user interface. These systems can support local media playback, streaming services, internet browsing, and application execution through an embedded operating system. The touchscreen display—whether integrated, foldable, or detachable—can be configured in various sizes and can include an In-Plane Switching (IPS) panel to provide high-definition visuals with accurate color reproduction and wide viewing angles.

The system's architecture can support interaction with external devices via wired or wireless protocols, such as Bluetooth or Wi-Fi, and can include input/output interfaces such as HDMI, optical, coaxial, auxiliary, and line-level audio ports. In some embodiments, the system can transmit video content to external displays, such as televisions or projectors, enhancing the visual experience in larger viewing environments. Microphone integration—via wired, wireless, or rechargeable options—can facilitate karaoke-style performances, with features including echo control, voice effects, and multichannel audio mixing. A recording function can allow users to capture performances to external storage devices such as USB drives.

In certain configurations, a detachable console screen may operate independently from a main hub through an onboard battery and wireless communication link, providing flexible user access and decentralized control. Additional features, such as multicolored LED lighting, support for multiple media formats (e.g., MP3, MP4, JPG), and expandable speaker connectivity, can be included to enhance the versatility and entertainment value of the system across a range of use scenarios.

Reference will now be made in detail to exemplary aspects of the present disclosure that are illustrated in the accompanying drawings. Wherever possible, the same reference numbers will be used throughout the drawings to refer to the same or like parts.

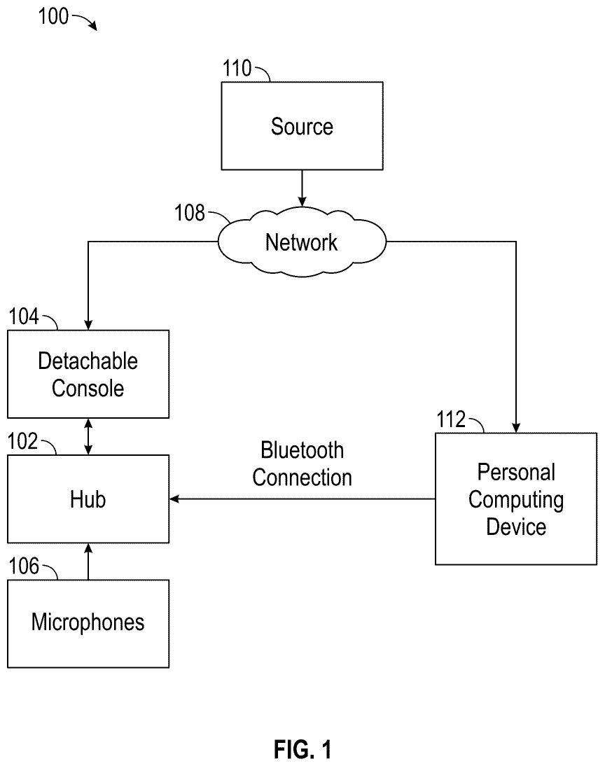

FIG. 1 illustrates a karaoke system 100 configured to enable the coordination and regulation of audio and visual elements across a plurality of components. The karaoke system 100 can comprise a computing environment including a detachable console screen 104, hub 102, and one or more microphones 106. The detachable console screen 104 can be capable of establishing a connection with a network 108, for example, to access one or more sources 110. Further, in some embodiments, one or more personal computing devices 112 can engage in communication with the hub 102 through Bluetooth connection.

The hub 102 can be configured to serve as a central control unit for coordinating and managing various functions and interactions within the karaoke system 100. In embodiments, the hub 102 can serve as a nexus for controlling audio and visual elements, facilitating the integration of multiple components. The hub 102 can be configured to enable the selection, playback, and mixing of karaoke content from various sources, including built-in MP3 and MP4 songs.

The detachable console screen 104 is configured to provide a portable an interactive interface for controlling and monitoring the karaoke system 100. In embodiments, the detachable console screen 104 can provide a user-friendly interface for navigating through the karaoke system's features, enabling users to search for songs, create playlists, and adjust settings. For example, the detachable console screen 104 can be configured to display karaoke lyrics, song information, and system controls in a clear and easily readable format, as well as to receive input from the user via touch-screen capabilities. When connected to the hub 102, the detachable console screen 104 can transmit and receive data, enabling synchronization of song selections, playlist management, and other functionalities.

Additionally, the detachable console screen 104 is configured to enable users to operate the karaoke system 100 independently when detached from the hub 102. In certain embodiments, the detachable console screen 104 can establish a connection with the hub 102 through a wireless medium, which may encompass Bluetooth, Wi-Fi Direct, or RF technology to establish a direct wireless link between the detachable console screen 104 and the hub 102, facilitating communication. Additionally, the hub 102 may incorporate a docking port to enable a physical connection between the detachable console screen 104 and the hub 102 when the detachable console screen 104 is positioned on the docking port.

The microphone 106 can be configured to receive and transmit audio signals during karaoke performances. In embodiments, the microphone 106 can enable users to engage with the karaoke system 100 wirelessly, providing freedom of movement and convenience. The microphone 106 can establish a wireless connection with the hub 102 via wireless communication protocols such as Bluetooth or RF technology.

The detachable console screen 104, as a component of the karaoke system 100, is configured to establish a network connection with the network 108. This connection enables the detachable console screen 104 to communicate with one or more sources 110, which may include servers or a bank of servers. Through this network connection, the detachable console screen 104 can access online music libraries and other online resources for expanded karaoke capabilities. The specific method of connecting the detachable console screen 104 to the network 108 may involve various networking protocols, such as Ethernet, Wi-Fi, or cellular connectivity, depending on the implementation of the karaoke system 100.

By connecting to the network 108, the detachable console screen 104 can access music from online sources, providing users with a wide selection of songs. Additionally, the network connection can enable the detachable console screen 104 to connect to entertainment or subscription services, granting users access to multimedia content such as music, videos, radio, and other forms of entertainment. Moreover, the network connection can facilitate software updates for the karaoke system 100. For example, the detachable console screen 104 can establish a connection to external sources to download and install software updates, ensuring the karaoke system 100 remains up to date with the latest features and improvements.

Additionally, as depicted in FIG. 1, in some embodiments, a personal computing device 112, such as a smartphone, tablet, or computer, can establish a connection with the karaoke system 100, either through Bluetooth or an optional direct link to the hub 102 to allow the personal computing device 112 to communicate with the hub 102 to access certain features and functionalities of the karaoke system 100.

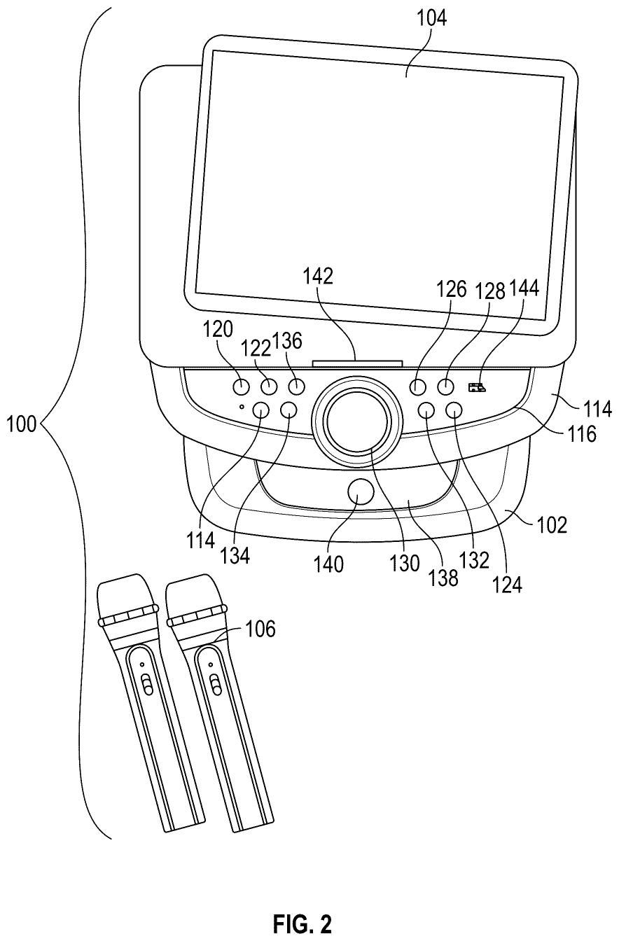

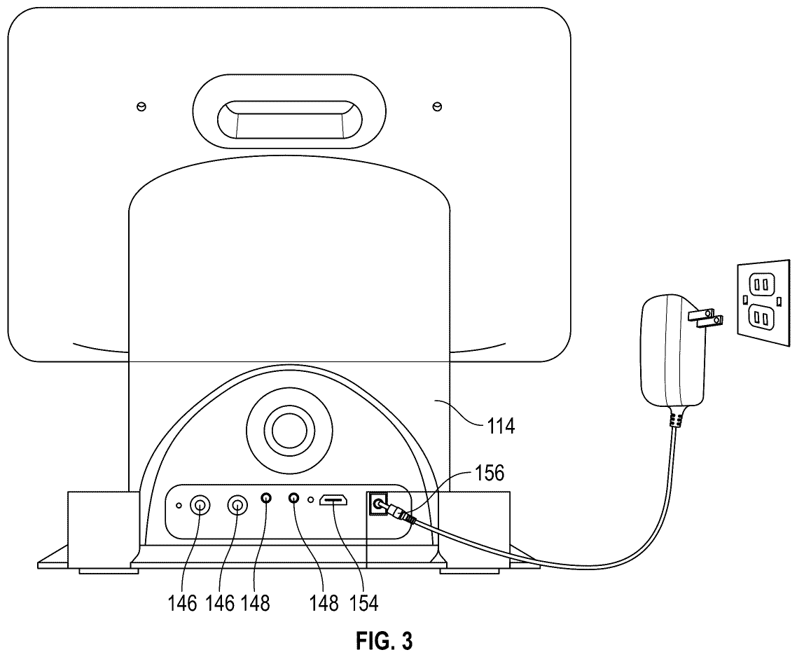

With additional reference to FIGS. 2-3, the hub 102 of the karaoke system 100 can comprise a housing 114 that can encompass various components and features. In some embodiments, the housing 114 can be configured to enclose and protect the internal elements of the hub 102. Additionally, the housing 114 can include a docking port 142, allowing for a physical connection between the hub 102 and the detachable console screen 104. The docking port 142, which in some embodiments can include a magnetic coupling and/or inductive charging, can facilitate secure attachment and reliable communication between the hub 102 and the detachable console screen 104. For example, in some embodiments, the docking port 142 can incorporate one or more permanent magnets to ensure a strong magnetic connection. The docking port 142 may also feature an alignment guide 143 to ensure proper positioning of the detachable console screen 104 and/or conductive pins to facilitate inductive charging, thereby enabling efficient power transfer and data communication.

To enable user-friendly control and navigation, the housing 114 can incorporate a control panel 116. The control panel 116 may include a number of buttons, control knobs, or similar interface elements. These buttons can include a power/standby button 118 for turning the karaoke system on or off, a play/pause button 124 for controlling the playback of karaoke content, a forward seek button 126 for skipping forward in the content, and a rearward seek button 128 for rewinding the content.

Moreover, a volume/effects control knob 130 can be provided on the control panel 116, allowing users to adjust a master output and microphone input volume level, apply echo effects to the karaoke output, and select functions on the hub 102. Additionally, a voice effect button 132 can be included for activating voice modification or enhancement features. A record button 134 can enable users to record audio of the karaoke event for later playback. Furthermore, a lights button 136 can be incorporated to control the activation and deactivation of one or more lights 138 integrated within the hub 102. A vocal off button 120 can reduce the sound input from a Bluetooth connected input device.

In some embodiments, the detachable console screen 104 can also include a camera 140, which can be configured to capture video. For example, the camera 140 can enable users to record their performances visually, adding an immersive element to the karaoke experience.

To facilitate connectivity and versatility, the hub 102 can include various physical connections. With continued reference to FIGS. 2-3, these connections can include ports such as a USB port 144 for connecting external storage devices, an auxiliary connection 146 for linking to external audio devices or inputs, a line out connection 148 enabling connection to external speakers for audio output, at least one microphone input socket 147 for connection to a wired microphone, an optical input 149 and a coaxial input 150, enabling connection with an audio-visual display unit for enhanced the sound performance, and an HDMI output 154 for establishing an audio-video output to external displays such as televisions enabling display on a larger screen. Additionally, a power input 156 is included to provide a supply of electrical power to the hub 102.

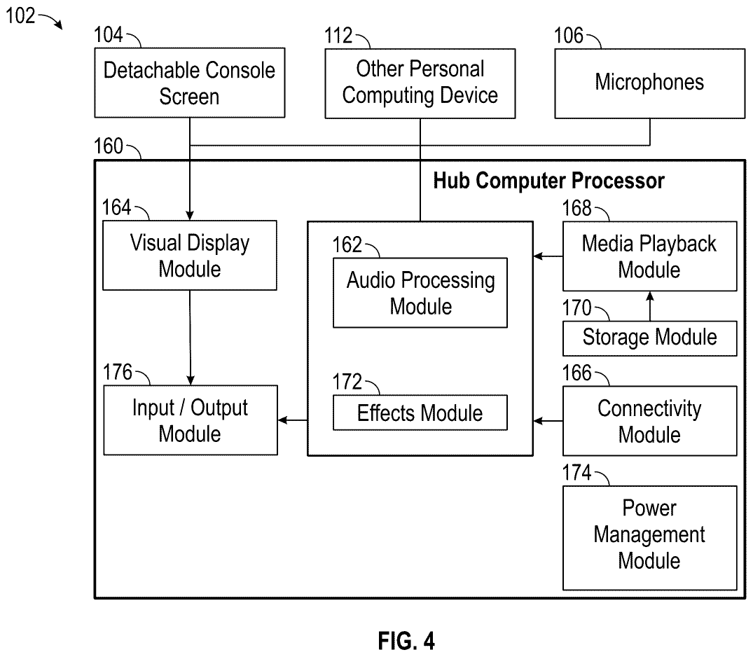

As further depicted in FIG. 4, the hub 102 can integrate a hub computer processor 160, which can comprise a plurality of modules. These modules may include, but are not limited to, an audio processing module 162, visual display module 164, connectivity module 166, media playback module 168, storage module 170, effects module 172, power management module 174, input/output module 176, and other modules designed to perform specific functions within the karaoke system. The hub computer processor 160 coordinates the operation of these modules to ensure the smooth functioning of the karaoke system 100.

The audio processing module 162 is configured to perform a sequence of operations to handle the processing and manipulation of audio signals within the karaoke system 100. In embodiments, the audio processing module 162 is responsible for ensuring high-quality audio output, synchronizing vocals and music, and applying audio effects as desired.

Upon receiving audio input from the microphones 106 or other sources including the play/pause button 124, buttons 126, 128, and the volume/effects control knob 130 among others, the audio processing module 162 can perform operations such as amplification, equalization, and mixing to enhance and balance the audio signals. Additionally, the audio processing module 162 can adjust the volume levels of the vocals and music to achieve optimal audio output during karaoke performances.

In some embodiments, the audio processing module 162 can cooperate with the effects module 172 to apply various audio effects to enhance the sound output. For example, audio processing module 162 can add digital echo or reverb effects to simulate different acoustic environments, providing a more immersive and enjoyable karaoke experience. Additionally, the audio processing module 162 can incorporate voice enhancement features, such as pitch correction or vocal harmonization, to improve the overall sound quality and vocal performance.

The visual display module 164 can serve the purpose of controlling and managing the visual display of the HDMI output 154. In embodiments, the visual display module 164 can be configured to perform a sequence of operations that ensure the accurate and appealing presentation of visual content. In particular, the visual display module 164 can receive data, such as lyrics and accompanying visuals, from the appropriate sources within the karaoke system 100, and process the received data for display on an external display connected to the hub 102.

The connectivity module 166 can be configured to establish and manage various connections and network interactions within the karaoke system. In embodiments, the connectivity module 166 can perform a sequence of operations to facilitate communication, data transfer, and access to external resources. For example, in some embodiments, the connectivity module 166 can initiate the establishment of external connections, such as Bluetooth, optical input 149, coaxial input 150, USB port 144, and other connections 146, 147, 148, to enable communication between the hub 102 and external sources.

The media playback module 168 can be configured to handle the playback of various media formats (e.g., MP3, MP4, etc.) within the karaoke system 100. For example, the media playback module 168 can be configured to perform a sequence of operations that ensure smooth and synchronized playback of audio and visual content.

Initially, the media playback module 168 can receive the selected media from the storage module 170, to prepare the media for playback. Next, the media playback module 168 can decode and process the media data to extract audio and visual components. The media playback module 168 can utilize appropriate codecs and algorithms to ensure compatibility and optimal playback quality. For example, when playing an MP4 song, the media playback module 168 can decode the audio track to extract the vocals and music.

The media playback module 168 can process the audio data to apply any desired effects, such as equalization or echo, to enhance the sound output during the karaoke performance. Moreover, the media playback module 168 can handle control and navigation of the media playback, allowing users to play, pause, seek, or skip through the content as desired. For example, in embodiments, the media playback module 168 can respond to user commands from the control panel (e.g., via the play/pause button 124, buttons 126, 128 and the volume/effects control knob 130), further in communication with the audio processing module 162 or external input devices, enabling control over the playback process.

The storage module 170 can be configured to handle the storage and retrieval of data within the karaoke system 100 or a connected storage device. In embodiments, the storage module 170 can be configured to receive and store various types of data, such as MP3, MP4, and JPG files.

The effects module 172 can be configured to apply various audio effects to enhance the karaoke experience. For example, in some embodiments, the effects module 172 can perform a sequence of operations to manipulate and control the audio output according to user preferences. The effects module 172 can receive audio input from the microphones 106 or other sources. Thereafter, the effects module 172 can analyze the audio signals and identify areas where effects can be applied to enhance the sound quality or create desired audio effects. The effects module 172 can process the audio signals using algorithms and techniques specific to each effect, which may include operations such as equalization, reverb, echo, pitch correction, or modulation to modify the audio characteristics.

For example, the effects module 172 can apply echo effects to create a reverberating sound, simulating different acoustic environments. Additionally, the module can incorporate equalization to adjust the frequency response, allowing users to fine-tune the audio output according to their preferences.

Moreover, the effects module 172 can provide pitch correction capabilities, helping users stay in tune during the karaoke performance. Furthermore, the effects module 172 may include voice modulation effects, allowing users to modify their voice characteristics. This can range from changing the gender or tone of the vocals to creating unique vocal effects or harmonies.

The power management module 174 can be configured to efficiently manage power distribution and battery charging within the karaoke system through the performance a sequence of operations to optimize power usage and ensure the uninterrupted operation of the system. In some embodiments, the power management module 174 performs operations to regulate power distribution among the various components of the karaoke system.

For example, when the detachable console screen 104 is connected to the hub 102, the power management module 174 can ensure that the detachable console screen 104 receives adequate power for its operation. Moreover, the power management module 174 can handle battery charging operations, for example by monitoring the battery level of the detachable console screen 104 and initiating charging, via the docking port 142 when necessary. Simultaneously, the power management module 174 can manage power distribution to other components, such as the audio processing module, visual display module, and connectivity module, to maintain system stability and optimal performance.

The input/output module 176 can be configured to handle the output of processed audio signals and manage visual display outputs. Specifically, this module can receive audio signals that have been processed by the audio processing module 162 and the effects module 172. The processed audio signals are then directed to appropriate output channels. Additionally, the input/output module 176 can manage the visual display by interfacing with the detachable console screen 104 and controlling the HDMI output 154, ensuring that both audio and visual signals are appropriately transmitted to their respective output devices.

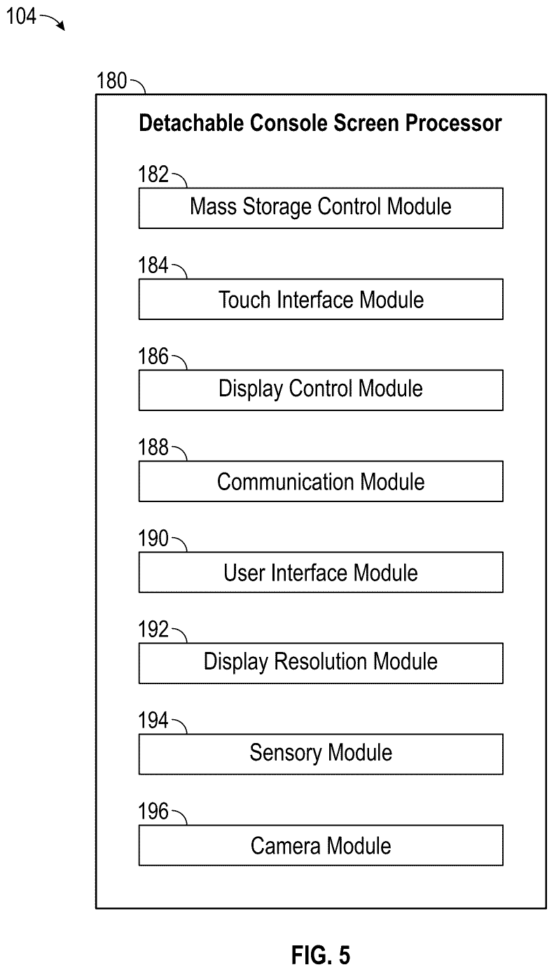

With additional reference to FIG. 5, the detachable console screen 104, can include a detachable screen console processor 180 including a plurality of modules configured to contribute to its functionality and performance. These modules can include a mass storage control module 182, touch interface module 184, display control module 186, communication module 188, user interface module 190, display resolution module 192, and sensory module 194, camera module 196, and other modules designed to perform specific functions within the karaoke system. The detachable screen console processor 180 coordinates the operation of these modules to ensure the smooth functioning of the karaoke system 100. In embodiments, the detachable console screen 104 can be a standalone tablet designed to establish a connection with the hub 102, thereby allowing for flexibility and cost-effectiveness. The users can utilize this standalone tablet for their daily use and communicate with the hub 102 for karaoke-related operations.

The mass storage control module 182 can be configured to manage the non-volatile, non-transitory storage for the karaoke system 100. The mass storage control module 182 can handle the interaction with various computer-readable data storage media, providing storage for data and instructions necessary for the operation of the karaoke system 100. Such computer-readable data storage media can include, but are not limited to, RAM, ROM, EPROM, EEPROM, flash memory, or other suitable storage mediums. The mass storage control module 182 can ensure that all data and instructions are readily accessible for the system's processes, contributing to the overall functionality and performance of the detachable console screen 104 and its associated modules.

The touch interface module 184, as part of the detachable console screen 104, can be configured to enable user interaction through touch input. In embodiments, the touch interface module 184 can perform a sequence of operations to accurately detect and interpret touch gestures, facilitating seamless control and navigation within the karaoke system.

For example, the touch interface module 184 can receive touch input from the user on the detachable console screen 104. The touch interface module 184 can utilize touch-sensitive technology, such as capacitive or resistive touch sensors, to detect and track the position and movement of the user's fingertips. Thereafter, the touch interface module 184 can process the touch input data, translating it into meaningful commands and actions within the karaoke system, identifying various touch gestures, such as taps, swipes, pinches, or multi-finger gestures, and maps them to specific functions or operations.

For example, a single tap on the detachable console screen 104 can be interpreted as a button press to select a song or activate a menu option. A swipe gesture can allow users to scroll through song lists or navigate between different screens. Pinching gestures can be used for zooming in or out on visual content, such as lyrics or images.

The display control module 186 can be configured to manage and control the visual display within the karaoke system through the performance of a sequence of operations to ensure the accurate rendering, synchronization, and presentation of karaoke lyrics, song information, and system interface elements.

Initially, the display control module 186 receives the necessary data, such as karaoke lyrics, visuals, and user interface elements, from the appropriate sources within the karaoke system. Thereafter, the display control module 186 can process the received data, performing operations such as formatting, rendering, and layout adjustments, while ensuring that the displayed content is visually appealing, legible, and properly synchronized with the audio playback.

For example, when displaying karaoke lyrics, the display control module 186 can ensure that the lyrics are presented in a clear and readable format, with appropriate line breaks, font styles, and synchronization with the music playback. It may also incorporate visual cues, such as highlighting or color changes, to guide users during karaoke performances.

Furthermore, the display control module 186 can manage the timing and synchronization of visual elements with the audio playback, ensuring that the displayed visuals, such as karaoke graphics or videos, are properly synchronized with the audio output, enhancing the immersive karaoke experience.

The communication module 188 can be configured to facilitate communication between the detachable console screen 104 and the hub 102. In embodiments, the communication module 188 can perform a sequence of operations to establish, maintain, and manage the communication link, enabling seamless data exchange and synchronization between the two components.

Initially, the communication module 188 can initiate the establishment of the communication link between the detachable console screen 104 and the hub 102 utilizing different connection technologies, such as Bluetooth or Wi-Fi, or wired connections, such as USB or HDMI, to establish a reliable and secure connection. Thereafter, the communication module 188 module can ensure continuous and uninterrupted communication between the detachable console screen 104 and the hub 102 through the performance of operations to monitor the connection status, detect any disruptions or interferences, and automatically re-establish the connection if necessary. If the connection is weakened or lost, the communication module 188 can initiate reconnection attempts to restore the communication link, minimizing disruptions in the karaoke experience.

Furthermore, the communication module 188 can manage data exchange between the detachable console screen 104 and the hub 102, facilitating the transfer of commands, settings, song selections, and other relevant data, ensuring that both components stay in sync and operate harmoniously. In embodiments, the communication module 188 can handle bidirectional communication, allowing the detachable console screen 104 to send feedback or responses back to the hub 102, thereby enabling interactive features and real-time updates, enhancing the usability and responsiveness of the karaoke system.

The user interface module 190 can be configured to provide an intuitive and user-friendly interface for controlling and interacting with the karaoke system 100. For example, the user interface module 190 can present a visually appealing and organized layout on the detachable console screen 104 through an arrangement of menus, buttons, and other interface elements in a logical manner, facilitating easy navigation and intuitive control for users.

The user interface module 190 can receive user input from touch gestures or other input devices, such as buttons or a stylus. Thereafter the user interface module 190 can interpret the user's actions and maps them to specific functions within the karaoke system, allowing users to select songs, adjust settings, create playlists, and perform other operations with ease. For example, users can navigate through song lists by swiping or scrolling on the detachable console screen 104, and tap on a specific song to select it for playback. The user interface module 190 can translate these touch gestures into corresponding actions, providing a seamless and enjoyable browsing experience.

Furthermore, the user interface module 190 may provide real-time feedback and visual cues to guide users during karaoke performances. The user interface module 190 can highlight selected options, display progress indicators, or provide on-screen prompts to assist users in their interactions with the karaoke system.

The display resolution module 192 can be configured to manage and optimize the resolution and quality of the visual display. In embodiments, the display resolution module 192 can perform a sequence of operations to ensure that the displayed content is presented with optimal clarity, sharpness, and color accuracy.

For example, the display resolution module 192 can receive the visual content to be displayed on the detachable console screen 104. Thereafter, the display resolution module 192 can analyze the content and determines the appropriate resolution and display settings for optimal presentation. Next, the display resolution module 192 can adjust the resolution and scaling of the visual content to match the capabilities of the detachable console screen 104, ensuring that the content is displayed at the native resolution of the screen, maximizing sharpness and clarity.

For example, if the detachable console screen 104 has a specific native resolution, the display resolution module 192 can adjust the visual content to match that resolution to ensure that the content is presented with optimal sharpness and avoids any distortions or blurriness due to improper scaling. Furthermore, the display resolution module 192 can perform color calibration and adjustment to ensure accurate color reproduction, taking into account factors such as color profiles, contrast ratios, and brightness levels to present the visual content with color accuracy and vibrancy.

The sensory module 194 can be configured to detect and respond to external factors that enhance the user experience through the performance a sequence of operations to analyze sensory inputs and provide appropriate responses. In some embodiments, the sensory module 194 can receive sensory input from various sensors integrated into the detachable console screen 104, including ambient light sensors, orientation sensors, or other relevant sensors depending on the design of the karaoke system 100. Thereafter, the sensory module 194 can process the sensory input, analyzing factors such as ambient light conditions or screen orientation to determine the optimal display settings or adjustments based on the detected sensory information.

For example, if the ambient light sensors detect low light conditions, the sensory module 194 may automatically adjust the display brightness to ensure optimal visibility. Similarly, if the orientation sensors detect a change in screen orientation, the sensory module 194 may adjust the display orientation accordingly to maintain the correct visual orientation. Moreover, the sensory module 194 may provide real-time feedback or responses based on the sensory input. For instance, it may activate haptic feedback or provide visual cues to indicate changes in sensory conditions or to enhance the user interaction with the detachable console screen 104.

The camera module 196 can be configured to enable the recording of video and the taking of photos by coupling the camera 140 to other components of the detachable screen console processor 180. In embodiments, the camera module 196 interfaces with the processor's various subsystems, managing the flow of visual data and enabling functionalities such as real-time video recording and photo capturing. This integration supports a range of multimedia applications, enhancing the user experience by providing robust audiovisual capabilities within the detachable console screen 104.

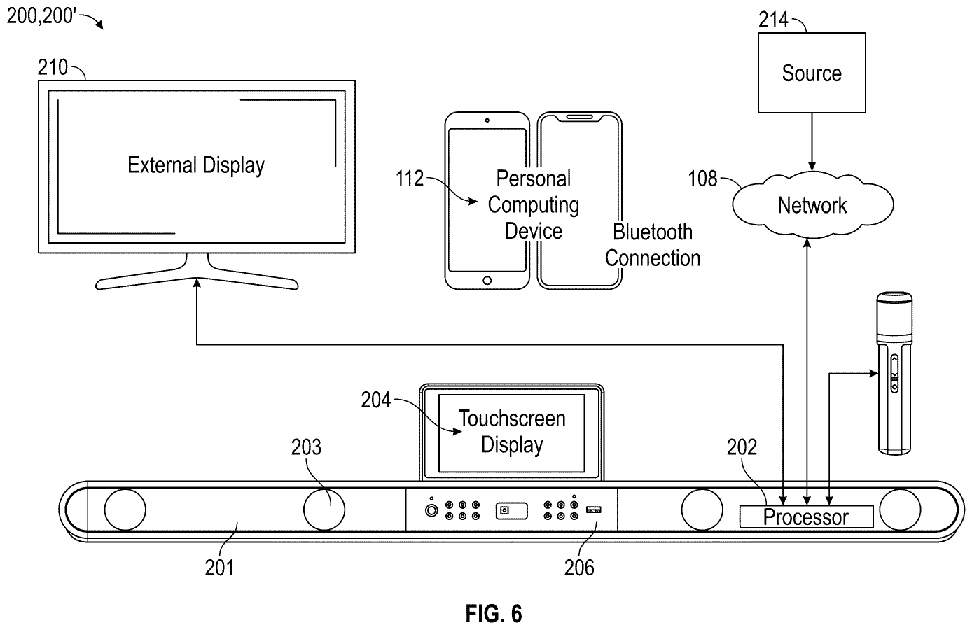

FIG. 6 illustrates a multifunctional sound bar system 200 that can be configured to manage and integrate audio, visual, and interactive functionalities across various components. As depicted, the multifunctional sound bar system 200 can include a housing 201 providing a mounting structure for a processor 202, a touchscreen display 204, and a control panel 206. Additionally, the multifunctional sound bar system 200 can include one or more microphones 208. The multifunctional sound bar system 200 can be operatively connected to an external display 210, such as a television or monitor. The multifunctional sound bar system 200 can also communicate with a network 108, enabling access to one or more sources 214 of multimedia content. Furthermore, the multifunctional sound bar system 200 can interface with a personal computing device 112, such as a smartphone or tablet, or devices such as headphones, virtual reality headsets, etc.

In some embodiments, the multifunctional sound bar system 200 can be configured to receive an audio input signal, amplify the signal, and optionally convert or filter the signal for playback through one or more integrated speakers 203. In embodiments, the processor 202 can serve as the central control unit of the multifunctional sound bar system 200, managing and coordinating its various functions. For example, the processor 202 can process audio and visual signals, facilitate communication between components, and enable user interactions. In embodiments, the processor 202 can support multimedia playback, voice command recognition, and connectivity with external devices, including the microphones 208, external display 210, network 108/source 214, and personal computing devices 112.

The touchscreen display 204 can be pivotably mounted to the housing 201, enabling the touchscreen display 204 to transition between different positions relative to the housing 201, enhancing usability in various settings. The touchscreen display 204 can provide an interactive interface for controlling and monitoring the multifunctional sound bar system 200. For example, the touchscreen display 204 can present graphical user interfaces enabling users to navigate system features, adjust settings, and view multimedia content. In embodiments, the touchscreen display 204 can be used to display song lyrics, enable video playback, and provide system controls.

The control panel 206 can include tactile interface elements, such as buttons, rotary knobs, and switches, to enable users to interact directly with the multifunctional sound bar system 200. In some embodiments, the control panel 206 can facilitate operations such as selecting audio or video input sources, adjusting microphone settings, or switching between different operational modes.

The microphones 208 can capture audio signals for various applications, including karaoke performances, voice commands, and video conferencing. In some embodiments, the microphones 208 can be wirelessly connected to the processor 202 via communication protocols such as Bluetooth or Wi-Fi.

The multifunctional sound bar system 200 can be configured to receive audio input from the external display 210 or an audiovisual input from source 214, transmit the audiovisual signal to an external display if applicable, and simultaneously amplify and/or process the corresponding audio signal for output through the integrated speakers 203.

The multifunctional sound bar system 200 can establish a network connection with the network 108, allowing access to one or more sources 214, which may include streaming services, cloud-based libraries, or other multimedia platforms. The network connection can employ various communication protocols, such as Ethernet, Wi-Fi, or cellular connectivity, depending on the implementation. Through this connection, the multifunctional sound bar system 200 can access a broad range of audio and visual content. For example, users may interact with applications running on the processor 202 and displayed on the touchscreen display 204, such as YouTube, Apple Music, Amazon Music, Spotify, Karafun, and other streaming services.

The multifunctional sound bar system 200 can further interact with personal computing devices 112. Personal computing devices 112 can enhance the functionality of the system by serving as additional input or control devices. Personal computing devices 112 can connect wirelessly via Bluetooth or Wi-Fi, or through a physical connection, such as an auxiliary input port, enabling additional features such as screen mirroring, remote control, or content sharing.

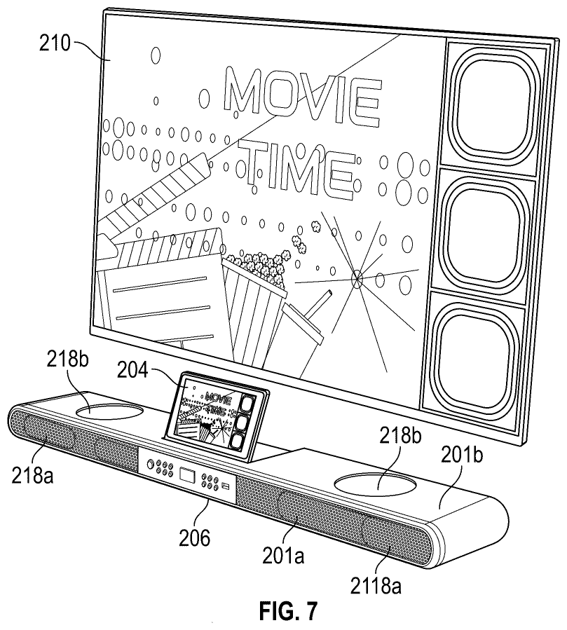

With reference to FIG. 7, a perspective view of the multifunctional sound bar system 200 is depicted in accordance with an embodiment of the disclosure. The multifunctional sound bar system 200 can include a housing 201 configured as an elongate tubular structure, which can enclose and protect internal components. The housing 201 can incorporate speaker grills 218a, for example, positioned along a front surface 201a of the housing 201 (e.g., providing protection for higher and mid-range speakers). Additionally, the housing 201 can include speaker grills 218b located along a top surface 201b of the housing 201 (e.g., providing protection for lower-range speakers).

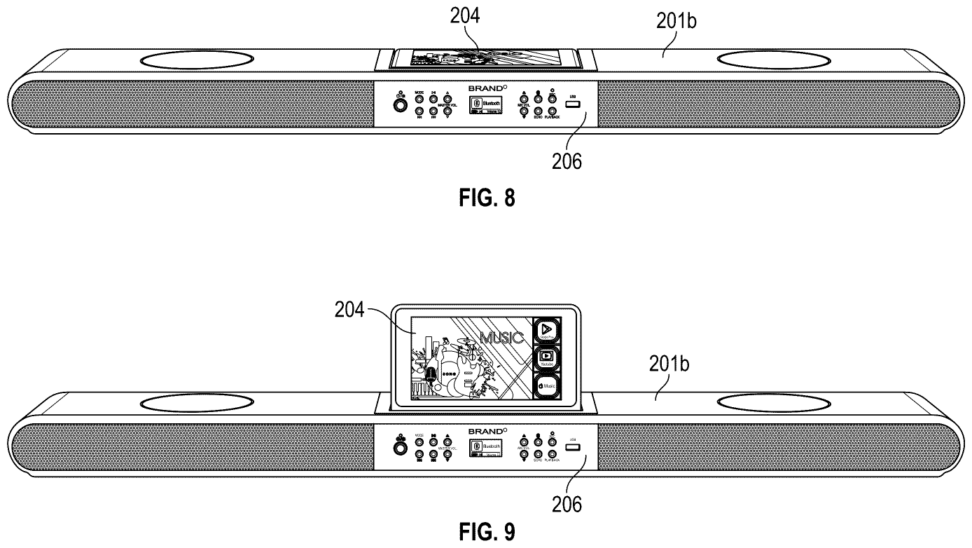

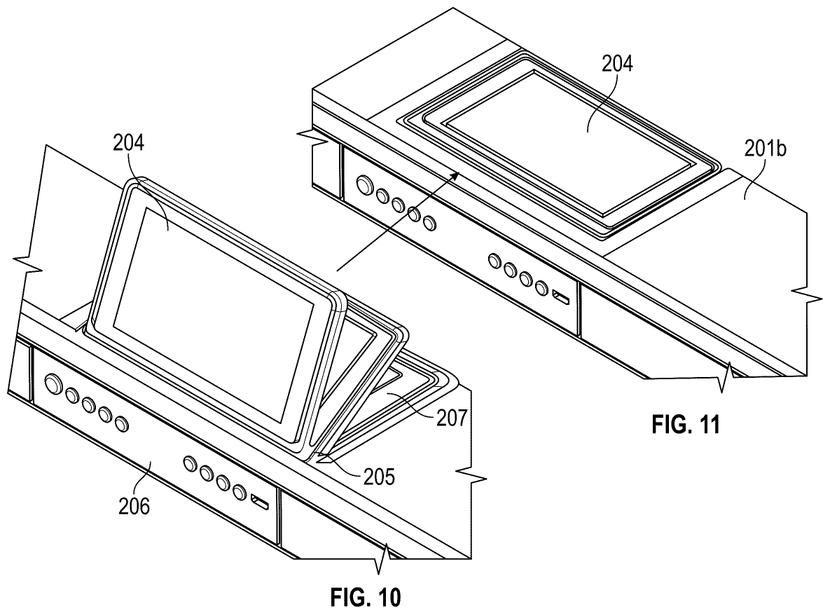

As depicted, in one embodiment, the touchscreen display 204 can be centrally positioned on the top surface 201b of the housing 201, between the speaker grills 218b. The touchscreen display 204 can be configured to provide a graphical user interface operatively connected to the processor 202, enabling users to control system functionality and access applications. In some embodiments, the touchscreen display 204 can be pivotable relative to the housing 201. For example, in one embodiment, the touchscreen display 204 can pivot between a stowed position (as shown in FIG. 8), where the display surface is substantially parallel to the top surface 201b of the housing 201, and a deployed position (as shown in FIG. 9), where the display surface is partially upright and angled away from the top surface 201b of the housing 201.

With additional reference to FIGS. 10 and 11, the touchscreen display 204 can transition between the deployed and stowed positions through a mechanical pivot or hinge 205. In some embodiments, the top surface 201b of the housing 201 can define a compartment 207 configured to receive a portion of the touchscreen display 204 when in the stowed position. In this configuration, only a front surface of the touchscreen display 204 may remain exposed on the exterior of the housing 201, providing a sleek and compact form factor while protecting the display from damage.

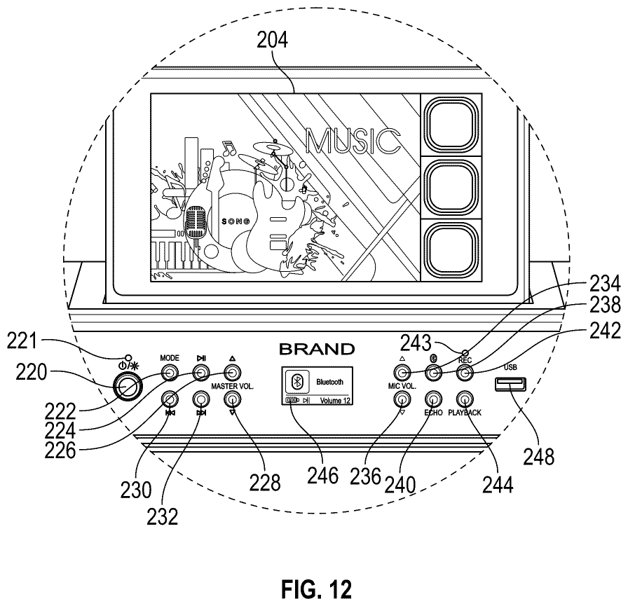

To facilitate intuitive control and interaction, the multifunctional sound bar system 200 can include a control panel 206, which, in embodiments, can be located along either of a front surface 201a or a top surface 201b of the housing 201. As depicted in FIG. 12, the control panel 206 can comprise various interface elements, each configured to provide specific functionality for managing the operation and output of the multifunctional sound bar system 200.

With continued reference to FIG. 12, the power/lights button 220 can serve a dual function of activating or deactivating the multifunctional sound bar system 200 and, in some embodiments, controlling the multicolored lighting effects associated with the speaker grills 218a-b. In some embodiments, pressing the power/lights button 220 can toggle the system between an operational state and a standby state, while holding the button for a specified duration can activate or deactivate the lighting effects. The power LED 221 can visually indicate the power status of the multifunctional sound bar system 200. For example, the power LED 221 can emit a steady illumination when the system is powered on and blink when in standby mode, providing users with a clear and immediate indication of the system's status.

The mode select button 222 can enable users to switch between different operational modes of the multifunctional sound bar system 200. For example, the mode select button 222 can allow the user to toggle between an auxiliary input mode, optical input mode, and coaxial input mode, etc., providing flexibility for connecting various audio sources.

The master volume up button 226 and the master volume down button 228 can allow users to adjust the overall audio output level of the multifunctional sound bar system 200. For example, the master volume up button 226 can incrementally increase the output volume level, while the master volume down button 228 can reduce the output volume level.

The play/pause button 224 can be configured to control the playback of multimedia content. For example, pressing the play/pause button 224 can toggle between starting and stopping the playback of a selected audio or video track, enabling users to easily manage content playback. The back/previous button 230 and the forward/next button 232 can enable users to navigate through playlists or track selections. For example, pressing the back/previous button 230 can skip to the beginning of the current track or move to the previous track, while pressing the forward/next button 232 can advance to the next track in the playlist.

The control panel 206 can also include buttons for managing microphone input. The microphone volume up button 234 and the microphone volume down button 236 can allow users to adjust the input level of the microphones 208, ensuring optimal audio balance during karaoke sessions or voice recordings. The echo effects button 240 can activate or adjust echo effects applied to microphone input. In some embodiments, pressing the echo effects button 240 can cycle through different levels of echo.

The Bluetooth pairing button 238 can facilitate wireless connectivity between the multifunctional sound bar system 200 and external devices such as personal computing devices 112. For example, pressing the Bluetooth pairing button 238 can initiate the pairing process, enabling the system to establish a connection with a smartphone, tablet, headphones, or VR headset for audio streaming or remote control functionality.

The record button 242 can enable users to initiate audio recording. For example, pressing the record button 242 can cause the multifunctional sound bar system 200 to capture microphone input and audio signals from connected devices, storing the recorded content on a USB-compatible storage device connected via the USB port 248. The record LED 243 can provide a visual indication of the recording status. For example, the record LED 243 can emit a steady light when recording and blink when recording is paused or in standby mode.

The record playback button 244 can allow users to playback recorded audio content directly from the USB storage device. For example, pressing the record playback button 244 can retrieve the most recent recording and output the audio through the multifunctional sound bar system 200. The control panel 206 can further include a USB port 248 configured to interface with USB-compatible storage devices. For example, the USB port 248 can support the storage of recorded audio content and the playback of pre-recorded files, enhancing the multifunctional sound bar system's versatility.

Additionally, the control panel 206 can include an LCD display 246 configured to provide real-time information about the multifunctional sound bar system 200. For example, the LCD display 246 can present details such as the current Bluetooth connection status, battery life, track information, playback status, and volume levels, offering users a comprehensive view of the system's operation.

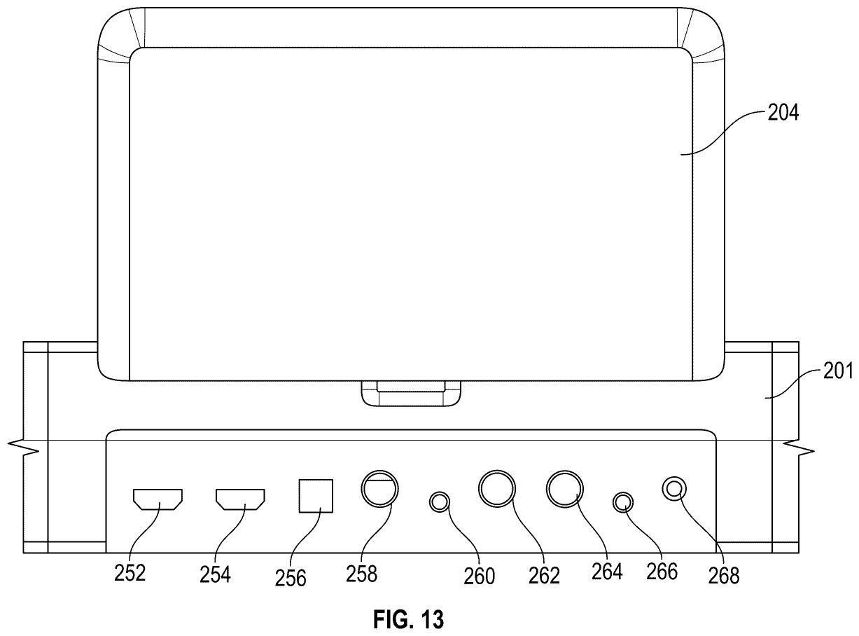

With additional reference to FIG. 13, which illustrates a rear close-up view of the multifunctional sound bar system 200, the housing 201 can include various physical connections to enhance the system's functionality and interoperability with external devices. Each connection can be configured to support specific types of inputs or outputs, facilitating versatile use of the multifunctional sound bar system 200.

The HDMI (ARC) input 252 can be configured to receive high-definition audio and video signals from an external source, such as a television or media player. The Audio Return Channel (ARC) functionality of the HDMI (ARC) input 252 enables bidirectional communication, allowing audio signals to be transmitted from the connected television back to the multifunctional sound bar system 200 for enhanced sound output.

The HDMI output 254 can provide a connection for transmitting video and audio signals from the multifunctional sound bar system 200 to an external display 210, such as a television or projector. For example, the HDMI output 254 can be used to display multimedia content, including video playback or karaoke lyrics, on the external display 210.

The optical input 256 can support the transmission of high-quality digital audio signals using an optical fiber cable. The optical input 256 can be configured to connect to devices such as gaming consoles, Blu-ray players, or televisions, ensuring compatibility with various optical compatible entertainment systems.

The coaxial input 258 can provide an alternative method for connecting digital audio sources to the multifunctional sound bar system 200. The coaxial input 258 can be used with devices that support coaxial audio output, allowing for integration into existing home entertainment setups.

The line out connection 260 can facilitate the connection of external speakers or amplifiers to the multifunctional sound bar system 200. For example, the line out connection 260 can be configured to transmit an analog audio signal, enabling users to expand their audio setup by adding additional sound components for a more immersive experience.

The first microphone input 262 and the second microphone input 264 can provide connectivity for microphones 208. These inputs can allow users to connect multiple microphones simultaneously, supporting group karaoke performances or other collaborative activities. In some embodiments, the microphone inputs 262 and 264 can include gain control or noise-canceling functionality to customize audio quality during use.

In some embodiments, the auxiliary input 266 can enable the multifunctional sound bar system 200 to connect to external audio sources using a standard 3.5 mm stereo jack or similar connection. For example, the auxiliary input 266 can allow users to connect smartphones, MP3 players, or other devices for audio playback, providing flexibility for integrating various personal devices into the system.

The DC power input 268 can be configured to supply electrical power to the multifunctional sound bar system 200. In embodiments, the multifunctional sound bar system 200 can be powered by a rechargeable power source in addition to the DC power input 268, enabling the multifunctional sound bar system 200 to function in portable settings without reliance on a fixed power outlet. In some embodiments, the rechargeable power source can be integrated within the housing 201 and can be recharged using standard charging adapters compatible with the DC power input 268.

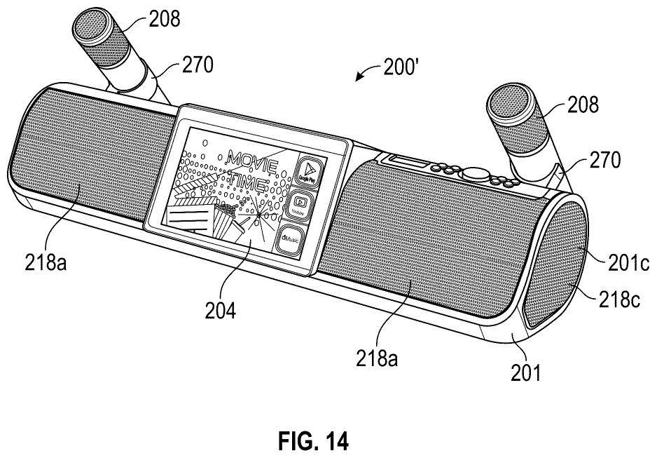

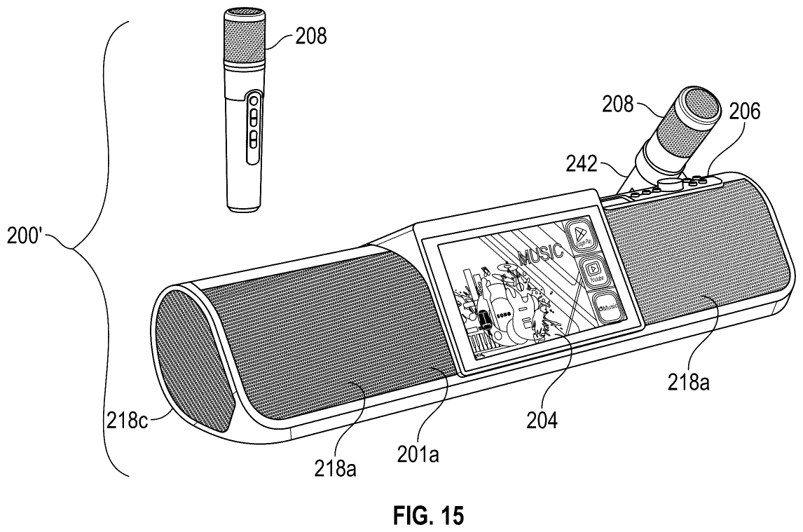

With reference to FIGS. 14 and 15, perspective views of an alternative embodiment of a multifunctional sound bar system 200′ are depicted in accordance with the disclosure. Similar to the previously described embodiment, the multifunctional sound bar system 200′ can include a housing 201 generally configured as an elongate tubular structure, designed to enclose and protect internal components, such as the processor 202, integrated speakers 203 and associated circuitry, while providing a robust exterior.

In this embodiment, the housing 201 can include speaker grills 218a positioned along the front surface 201a, for example to serve as protective covers for the higher and midrange speakers housed within the multifunctional sound bar system 200′. Additionally, the housing 201 can include speaker grills 218c, positioned on opposite ends 201c of the housing 201, configured to protect the lower-range speakers. The placement and orientation of the speaker grills can enhance the overall audio output by directing sound effectively toward the intended listening environment.

In some embodiments, the speaker grills 218a can be enhanced with LED lights or other color-illuminating elements, configured to provide visual effects synchronized with the audio output of the multifunctional sound bar system 200′. For example, the LED lights integrated into the speaker grills 218a can transition between different colors, intensities, or patterns based on the rhythm or tone of the audio being played, adding a dynamic visual element to the user's entertainment experience.

The touchscreen display 204 can be centrally positioned on the front surface 201a of the housing 201, between the speaker grills 218b. The touchscreen display 204 can be configured to provide a graphical user interface for controlling the processor 202 and accessing applications. In embodiments, the touchscreen display 204 can enable users to navigate menus, adjust system settings, control audio and lighting effects, and access multimedia content, such as music, video, or karaoke applications.

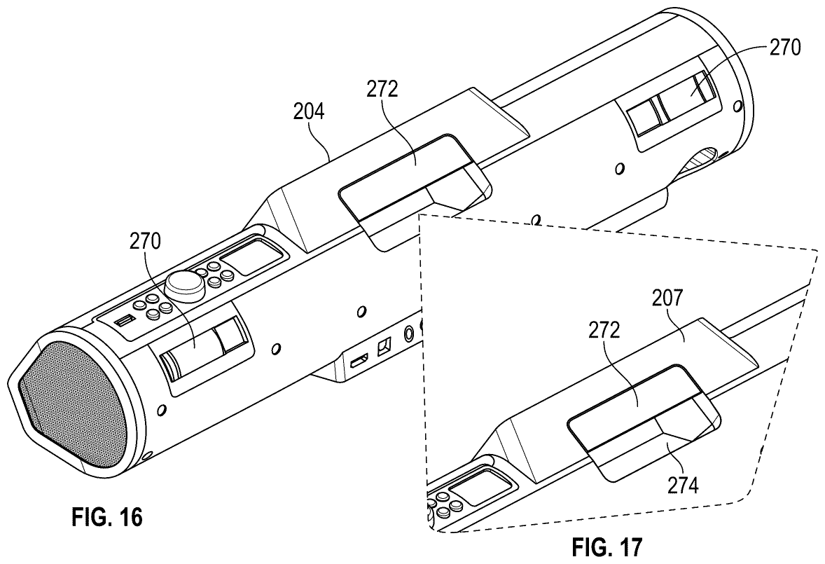

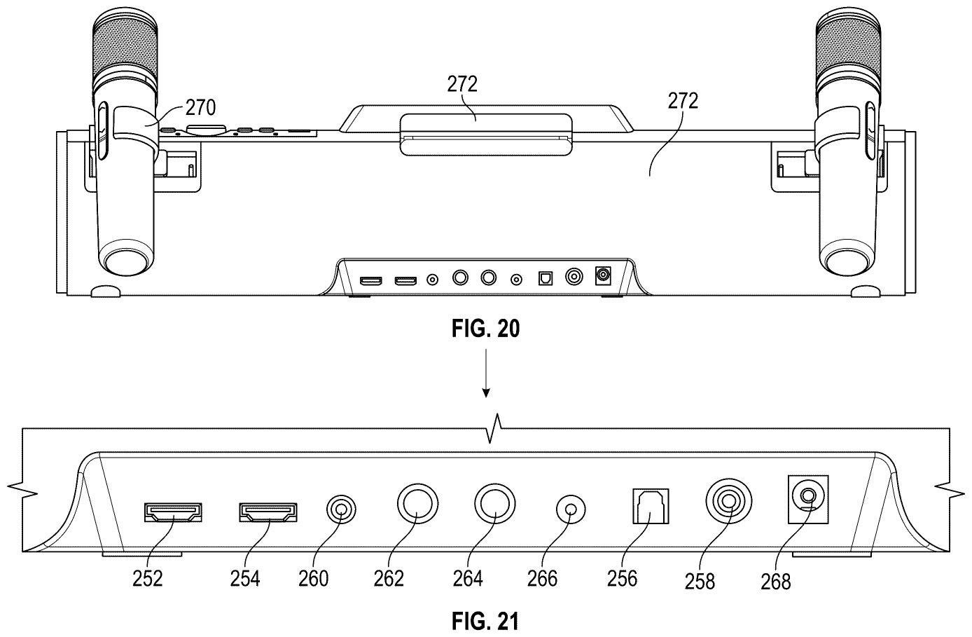

With additional reference to FIGS. 16 and 17, the housing 201 can be further configured to include microphone holders 270, designed to securely store the microphones 208 when not in use. In embodiments, the microphone holders 270 can be configured to transition between a microphone-receiving position (as depicted in FIGS. 14 and 20) and a stowed position (as depicted in FIG. 16). For example, in the stowed position, the microphone holders 270 can pivot or retract to be flush with an exterior surface of the housing 201, thereby maintaining a sleek and unobtrusive profile when the microphones 208 are not in use. This dual-position functionality can enhance both the aesthetic appeal and practical usability of the multifunctional sound bar system 200′.

In some embodiments, the housing 201 can also include a handle 272 to facilitate portability of the multifunctional sound bar system 200′. As depicted in FIGS. 16-17, the handle 272 can define a finger cup 274, extending below the top surface 201b of the housing 201 and positioned behind the touchscreen display 204. The finger cup 274 can be contoured to comfortably accommodate finger tips, allowing the multifunctional sound bar system 200′ to be easily carried from one location to another. The positioning of the handle 272 on the housing 201 ensures that the handle 272 does not interfere with the functionality or accessibility of other components, such as the touchscreen display 204 or control panel 206.

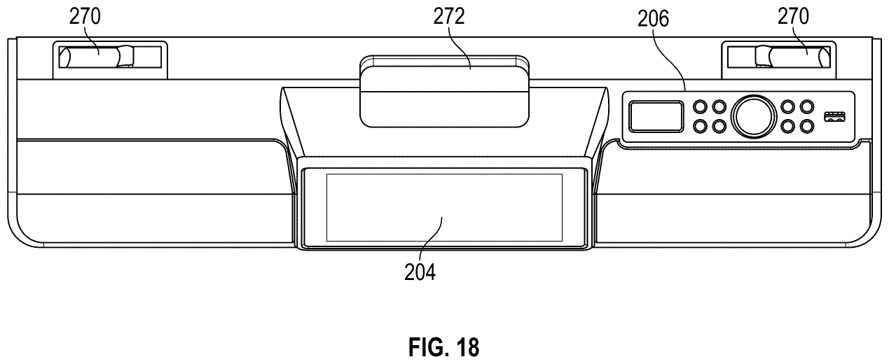

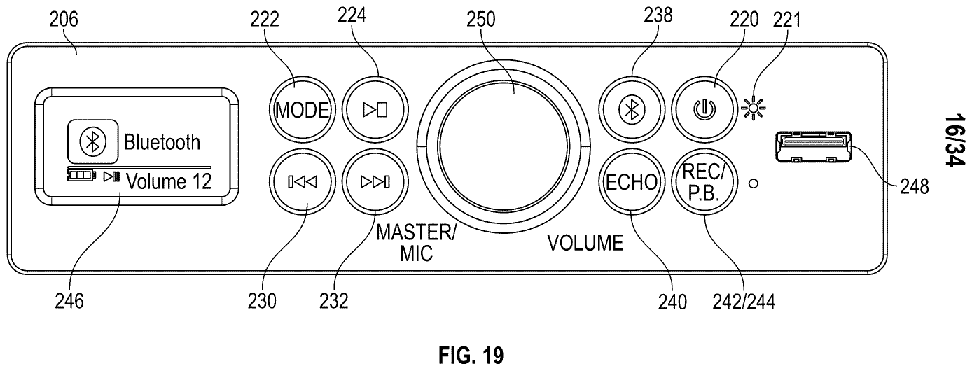

With reference to FIGS. 18-19, the control panel 206 is depicted in accordance with an embodiment of the disclosure. The control panel 206 can be positioned along the top surface 201b of the housing 201 and can provide a tactile interface for managing and interacting with the multifunctional sound bar system 200′. The control panel 206 can include a plurality of interface elements, each configured to perform specific functionalities that enhance user control and system usability.

The LCD display 246 can be configured to provide visual feedback regarding the operational status of the multifunctional sound bar system 200. In embodiments, the LCD display 246 can show information such as the current playback mode, volume levels, Bluetooth connectivity status, and track information. The display can also provide visual prompts for system settings and menu navigation, enhancing user interaction with the system.

The mode select button 222 can allow users to toggle between different operational modes of the multifunctional sound bar system 200. For example, the mode select button 222 can enable users to switch between Bluetooth mode, auxiliary input mode, or HDMI mode, providing seamless transitions based on the user's desired audio source.

The play/pause button 224 can be configured to control media playback. For example, a single press of the play/pause button 224 can initiate or pause the playback of multimedia content, while a double press may advance to the next track, depending on the application or media source in use. The back/previous button 230 can enable users to navigate backward through tracks or media playlists. For example, a single press of the back/previous button 230 can skip to the beginning of the current track, and a double press can move to the previous track in a playlist. The forward/next button 232 can allow users to navigate forward through tracks or media playlists. For example, pressing the forward/next button 232 can advance to the next track in a playlist or chapter in a video, providing a simple and intuitive method for content navigation.

A rotary knob 250 can provide an interface for managing multiple aspects of the multifunctional sound bar system 200′. For example, the rotary knob 250 can control volume levels for both the master audio output and microphone inputs. For example, pressing the rotary knob 250 and rotating it can adjust the master volume (denoted as “0”) or, alternatively, the microphone volume (denoted as “1”), depending on the operational context. The rotary knob 250 can also facilitate mode selection within the multifunctional sound bar system 200. For instance, pressing the mode select button 222 in combination with rotating the rotary knob 250 can cycle through various operational modes, including Console, HDMI, Bluetooth (BT), Auxiliary (AUX), USB, Coaxial (COX), and Optical (OPT), with each mode corresponding to a specific input source, enabling users to quickly and efficiently switch between connected devices or audio-visual inputs without navigating menus.

The Bluetooth pairing button 238 can facilitate wireless connectivity between the multifunctional sound bar system 200 and external devices, such as smartphones, tablets, or microphones 208. A single press of the Bluetooth pairing button 238 can initiate the pairing process, while an LED indicator may provide feedback on the pairing status.

The power/lights button 220 can serve a dual purpose, enabling users to power the multifunctional sound bar system 200 on or off and to control the lighting effects associated with the system. For example, a single press of the power/lights button 220 can toggle the system's power state, while a longer press can cycle through lighting modes or adjust the brightness of the integrated LED lights. The power LED 221 can provide a visual indicator of the system's power status. In embodiments, the power LED 221 can illuminate when the system is powered on and may blink or change color to indicate specific system states, such as standby mode, low battery, or ongoing updates.

The echo effects button 240 can allow users to adjust audio effects, such as adding echo to microphone input during karaoke performances. For example, pressing the echo effects button 240 can toggle through different echo intensity levels, enhancing vocal output based on user preference.

The combined record and playback button 242/243 can offer dual functionality. A press of the button in record mode can initiate the recording of audio input, such as microphone vocals or media playback, onto a connected USB storage device via the USB port 248. When in playback mode, pressing the same button can enable users to review the recorded content, providing a streamlined interface for capturing and replaying audio.

The USB port 248 can enable users to connect external USB storage devices for various purposes. For example, the USB port 248 can facilitate the storage of audio recordings, playback of preloaded multimedia content, or updates to the system's firmware. The port can also provide power to charge compatible devices, such as smartphones or tablets.

With reference to FIGS. 20-21, rear close-up views of the multifunctional sound bar system 200′ are depicted in accordance with an embodiment of the disclosure. The housing 201 defines various physical connections positioned to facilitate communication with external devices and enhance the overall functionality and versatility of the system.

An HDMI (ARC) input 252 can be configured to receive audio signals from external devices, such as televisions, streaming devices, or gaming consoles, via Audio Return Channel (ARC) technology, enabling multifunctional sound bar system 200′ to act as a central audio processing unit, enabling users to enjoy enhanced sound quality from their video content without the need for additional cables.

An HDMI output 254 can be configured to transmit high-definition video and audio signals to external displays, such as televisions or projectors, enabling users to project multimedia content generated or processed by the multifunctional sound bar system 200′ onto larger screens, providing an immersive audio-visual experience suitable for home entertainment, parties, or presentations.

A line out connection 260 can be configured to transmit audio signals from the multifunctional sound bar system 200′ to external audio devices, such as additional speakers or amplifiers, enabling scalability of the system, allowing users to expand their audio setup for larger venues or customized configurations.

A first microphone input 262 and a second microphone input 264 can facilitate wired connections for microphones, enabling users to connect one or more microphones directly to the multifunctional sound bar system 200′.

An auxiliary input 266 can provide a versatile connection point for external audio sources, such as smartphones, MP3 players, or portable music devices. By connecting to the auxiliary input 266 input, users can stream their personal audio collections or playlists through the multifunctional sound bar system 200′, enhancing its versatility as an entertainment hub.

An optical input 256 can enable receipt of digital audiovisual signals from external devices, such as televisions or DVD players. The optical input 256 can provide a lossless connection for transmitting audio, ensuring precise and clear sound reproduction, which can be particularly beneficial for high-fidelity audio setups.

A coaxial input 258 can also facilitate digital audio signal transmission, offering an alternative to the optical input 256 for devices that support coaxial audio output, ensuring compatibility with a wide range of audio sources, broadening the system's connectivity options.

A DC power input 268 can be configured to receive electrical power from an external power source to operate the multifunctional sound bar system 200′. This input can ensure stable and reliable power delivery, enabling the system to perform its functions efficiently. In embodiments, the DC power input 268 can also support charging of the internal battery, allowing the system to be used in portable or remote scenarios.

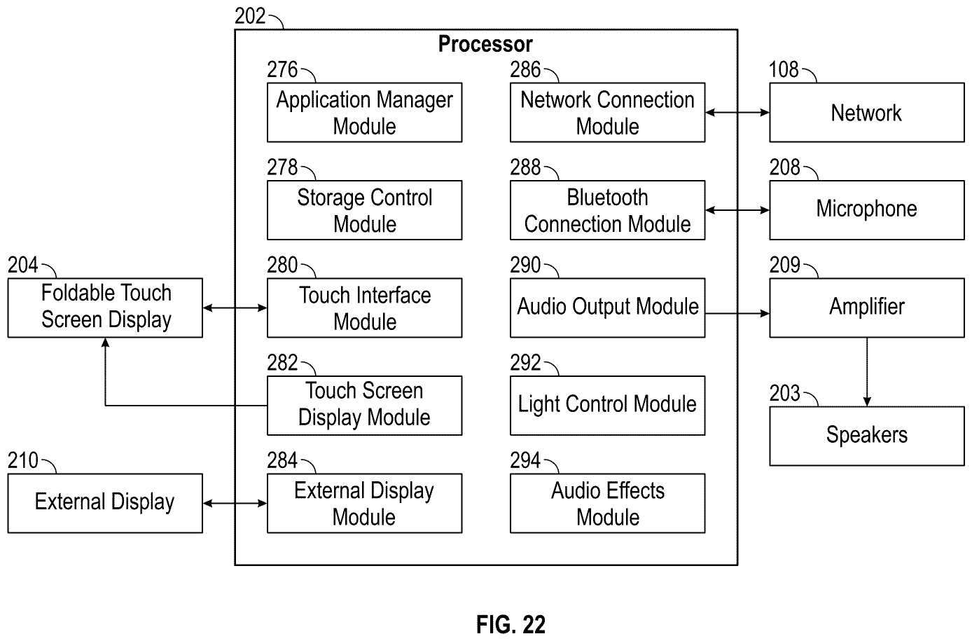

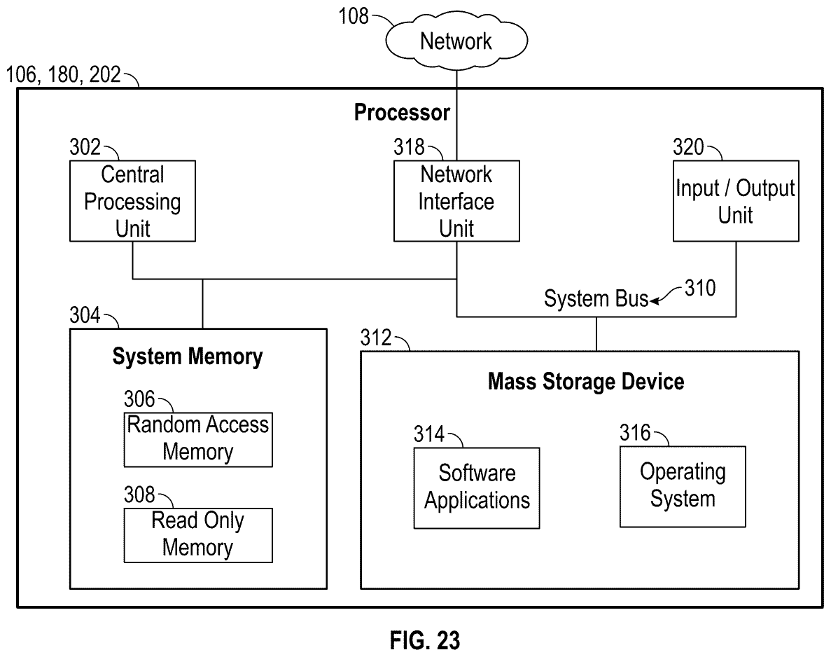

With reference to FIG. 22, a block diagram illustrates various components of the processor 202, as shown in FIG. 6, in accordance with an embodiment of the disclosure. For example, in one embodiment, the processor 202 can include multiple modules that cooperate to enable the functionality and performance of the multifunctional sound bar system 200, 200′ to perform functions such as application execution, data storage, audio processing, and connectivity.

In embodiments, the processor 202 can manage an integrated operating system (e.g., android, etc.) through an application manager module 276. The application manager module 276 can be configured to enable users to download and install applications from platforms such as the Google Play Store, the Apple App Store, etc. For example, a user may install a streaming service app, like Spotify or YouTube, to access personalized playlists or video content. Additionally, users can install utility applications or internet radio services, making the multifunctional sound bar system 200, 200′ highly customizable for entertainment or practical use.

To support these applications, a storage control module 278 can manage the storage of both installed apps and built-in content. For example, in one embodiment, the storage control module 278 can be preloaded karaoke songs (e.g., in MP4 format, etc.) allowing users to quickly select a song for a karaoke session. The storage control module 278 can also ensure efficient organization and retrieval of data, such as user settings and saved playlists.

User interaction with the multifunctional sound bar system 200, 200′ can be facilitated by a touch interface module 280, which can be configured to interpret inputs from the touchscreen display 204. In embodiments, the touch interface module 280 can support gestures such as swiping to browse a song list or tapping to select a video. For example, a family member can use the touchscreen display 204 to queue up a karaoke performance, or adjust volume levels or lighting settings.

To ensure clear and dynamic visual presentation, a touch screen display module 282 can be configured to manage the information displayed on the touchscreen display 204. For example, the touch screen display module 282 can enable users to customize the home screen layout, rotate between different views, and easily locate installed applications. For example, a user could set a specific application, such as Amazon Music, as a shortcut on the home screen for quick access.

When larger screens are needed, an external display module 284 facilitates video output to devices such as televisions via the HDMI output 254, for example during parties or family gatherings, where lyrics or music videos can be displayed. In embodiments, a user can connect the multifunctional sound bar system 200, 200′ to an external display 210 to browse a web-based application or share personal photos and videos during a slideshow presentation.

The system's internet connectivity can be managed by a network connection module 286, which can support current Wi-Fi standards (e.g., 802.11 ax/b/g/n, etc.). The network connection module 286 can enable users to stream content directly from online services, download updates, or connect to cloud-based storage. For example, a user might stream a live concert or download additional karaoke tracks from a source 214 to enhance their music library.

Bluetooth functionality can be coordinated by a Bluetooth connection module 288, which can be configured to manage connections to microphones 208 or personal computing devices 112. During a karaoke performance, the Bluetooth connection module 288 can serve to mix vocal input from a microphone 208 with audio playback from a connected smartphone, creating a synchronized experience. Additionally, the Bluetooth connection module 288 can allow users to pair devices for hands-free control of the multifunctional sound bar system 200.

High-quality audio output can be provided by an audio output module 290, which can work with an integrated amplifier to power the stereo speakers housed in the multifunctional sound bar system 200. For example, in one embodiment, an amplifier 209 can provide an output of 2×10 W (RMS) with a peak power of 200 W for integrated speakers 203. In embodiments, the audio output module 290 can amplify vocals during karaoke or to provide voiceover during video.

Lighting effects can be managed by a light control module 292, which can be configured to synchronize the lighted speaker grills 220a with audio playback. For instance, the lights can pulse in rhythm with music during a party or remain static in a user-selected color for a more subdued setting.

An audio effects module 294 can add advanced features such as voice-changing effects, digital echo control, and recording capabilities. For example, a user might use audio effects module 294 to alter their voice for a playful karaoke performance, add reverb for professional sound quality, or record a vocal track mixed with music directly to a USB flash drive connected to USB port 248.

As depicted in FIG. 22, a processor (e.g., hub computer processor 160, detachable screen console processor 180, or processor 202 of the multifunctional sound bar system) can include at least one central processing unit (“CPU”) 302, a system memory 304, and a system bus 310 that interconnects the CPU 302 and the system memory 304. The system memory 304 can comprise random access memory (“RAM”) 306 and read-only memory (“ROM”) 308. The ROM 308 can store a basic input/output system configured to facilitate information transfer between components during system startup. Additionally, the processor can include or be operatively connected to a mass storage device 312 configured to store software instructions and data. The CPU 302, system memory 304, and mass storage device 312 can be implemented in any of the processor configurations described herein.

The mass storage device 312 can be connected to the CPU 302 via the system bus 310. The mass storage device 312 and its associated computer-readable data storage media can provide non-volatile, non-transitory storage for the processor system. Computer-readable data storage media can include any available non-transitory physical medium or article of manufacture from which the processor can read data and/or instructions. Examples include, but are not limited to, RAM, ROM, EPROM, EEPROM, flash memory, or other suitable storage media.

In some embodiments, the processor can operate in a networked environment, utilizing logical connections to remote devices over a network 108, such as a wireless network or the Internet. The network 108 can provide connectivity through various protocols and may include local area networks (LANs), wide area networks (WANs), the Internet, or any combination thereof.

The processor can connect to the network 108 through a network interface unit 318 linked to the system bus 310. The network interface unit 318 can facilitate communications with various types of networks and remote systems. Additionally, the processor can include an input/output controller 320 configured to process input from user interface devices such as touchscreens, microphones, or physical buttons, and to provide output to display screens or other output components.

The mass storage device 312 and the RAM 306 can store software instructions and data, including an operating system 316 suitable for managing overall system functionality. Additionally, the mass storage device 312 and/or RAM 306 can store software applications 314 configured to execute various tasks. When executed by the CPU 302, these instructions can cause the processor to implement the features and functionality described throughout this disclosure.

The disclosed systems provide a unified platform for delivering interactive audio-visual entertainment experiences through integrated or detachable touchscreen interfaces, robust audio output, and broad application support. In some embodiments, a detachable or foldable touchscreen display can be configured to operate independently of a central hub using integrated power and wireless connectivity, such as Bluetooth. These displays, which may feature high-definition IPS panels and capacitive touch interfaces, allow users to navigate playlists, control settings, and launch applications. Compatibility with platforms such as Android and support for Google Mobile Services can further expand functionality by enabling access to popular streaming and karaoke apps.

Whether implemented as a karaoke hub or multifunctional sound bar, the system can support playback of media formats including MP3, MP4, and JPG, with recording capabilities that allow performances to be captured and saved to external USB storage. HDMI and other output interfaces can enable video content, such as karaoke lyrics or media playback, to be displayed on external screens for larger audiences. Additional input and output options—such as coaxial, optical, auxiliary, and line-level ports—provide flexibility in integrating microphones, active speakers, and other peripheral devices.

A central processor coordinates the functions of the system and can include modules for application management, content storage, Bluetooth and network connectivity, and audio effects. These modules enable streaming, local playback, recording, and advanced audio control features such as voice modulation and echo effects. Audio playback can be delivered through integrated stereo speakers powered by an onboard amplifier, with lighting effects synchronized via LED control modules to enhance the visual experience.

Designed for portability, adaptability, and ease of use, the system supports multiple modes of interaction through both touchscreen and tactile control elements. Its modular architecture allows it to serve as a compact all-in-one entertainment unit or integrate seamlessly into larger multimedia environments. The flexible design and extensive connectivity options make the system suitable for home use, group gatherings, or professional entertainment settings.

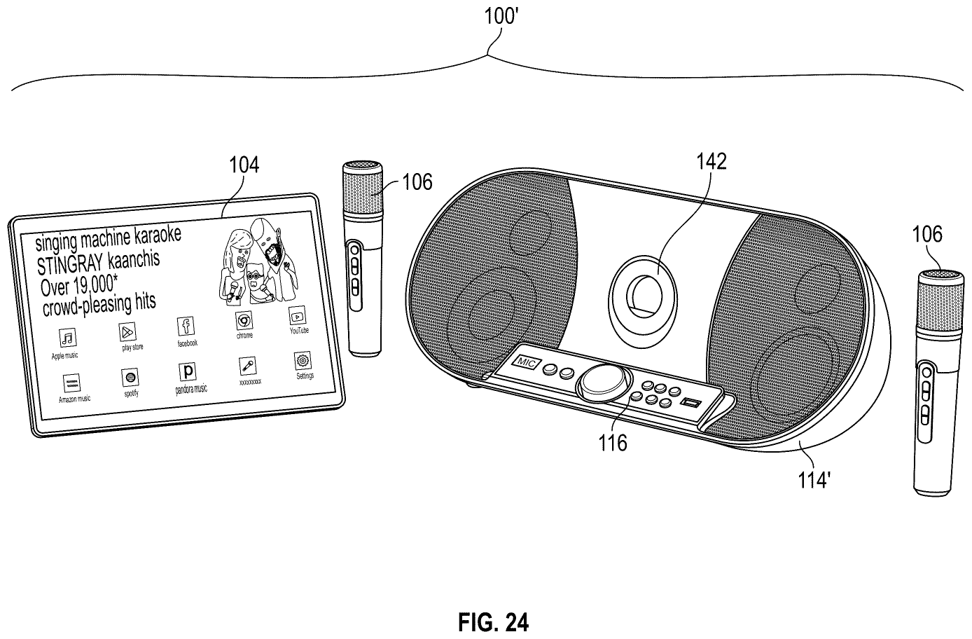

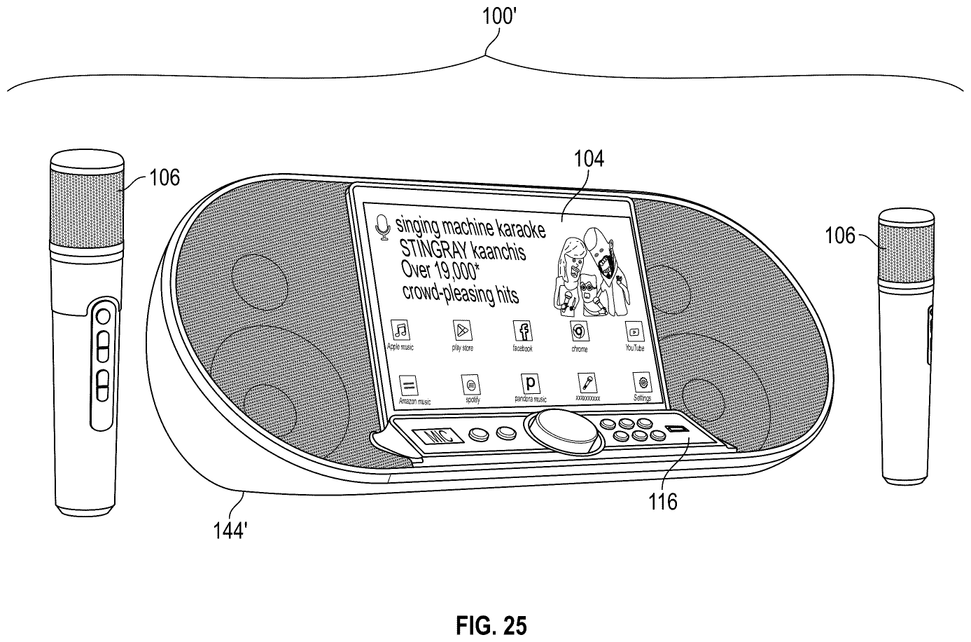

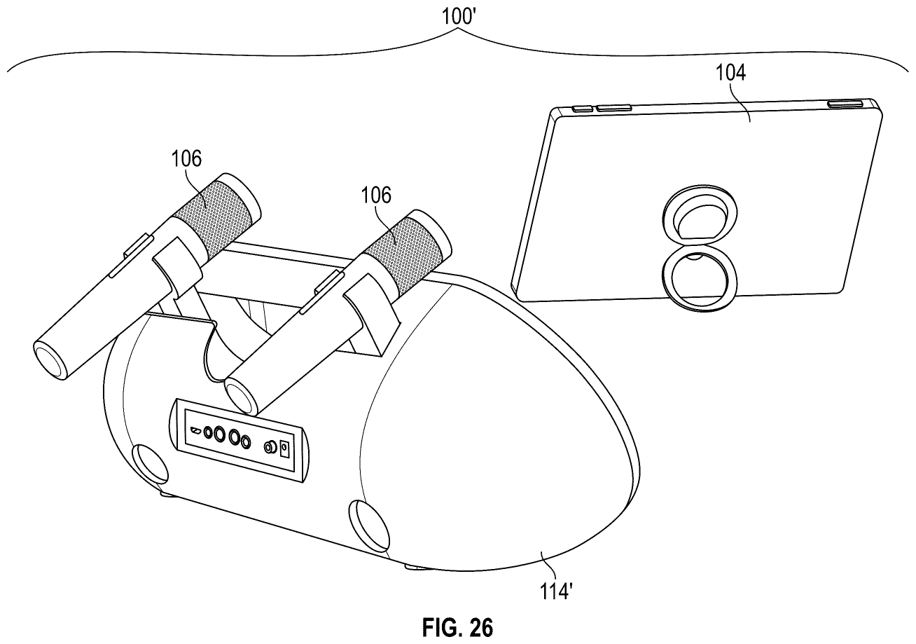

With additional reference to FIGS. 24-26, a second embodiment of a karaoke system 100′ is depicted in accordance with an embodiment of the disclosure. As depicted, the housing 114′ can be generally oval-shaped, featuring a recessed area defining the control panel 116 and docking port 142. Other components, features, and aspects of the karaoke system 100′ can be similar to those of the previously disclosed embodiment.

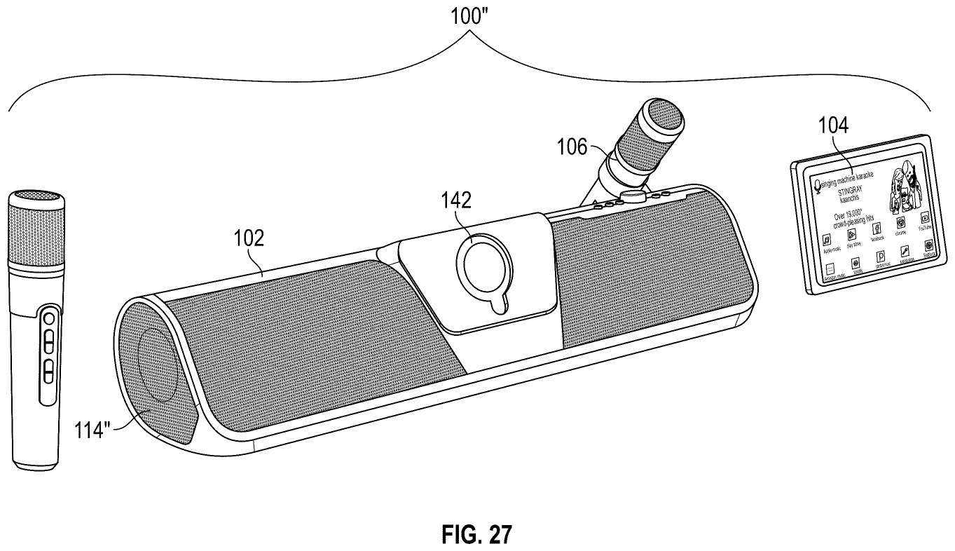

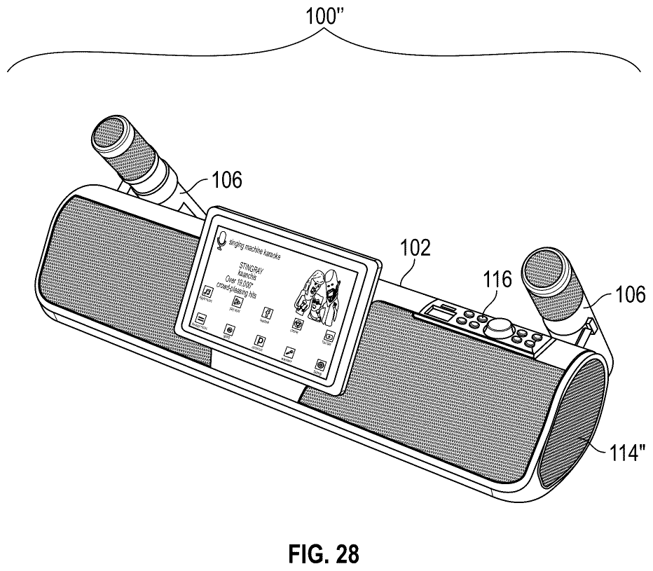

With additional reference to FIGS. 27-28, a third embodiment of a karaoke system 100″ is depicted in accordance with an embodiment of the disclosure. As depicted, the housing 114″ can be generally elongated, defining a centrally located docking port 142, with a control panel featured on a top portion of the housing 114″. Other components, features, and aspects of the karaoke system 100″ can be similar to those of the previously disclosed embodiment.

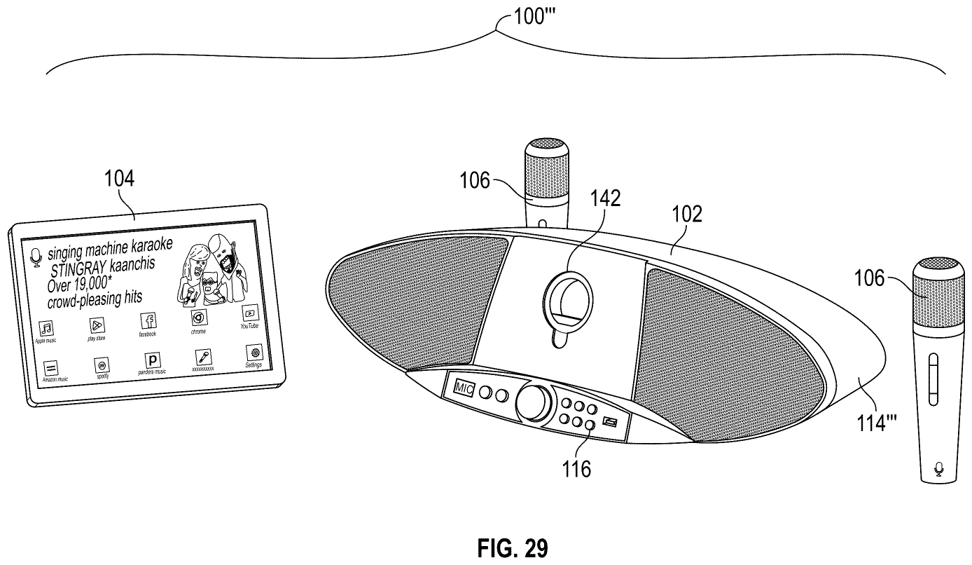

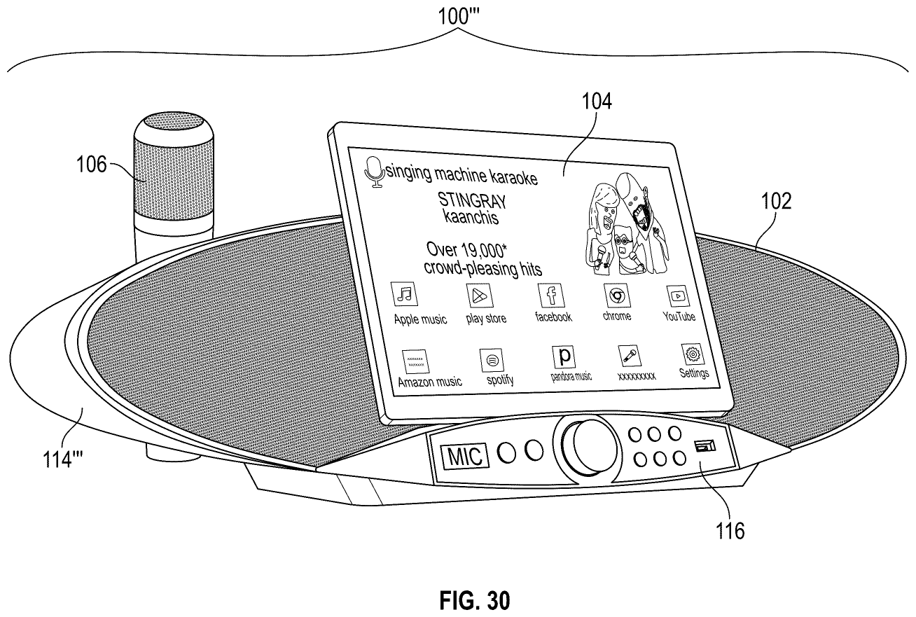

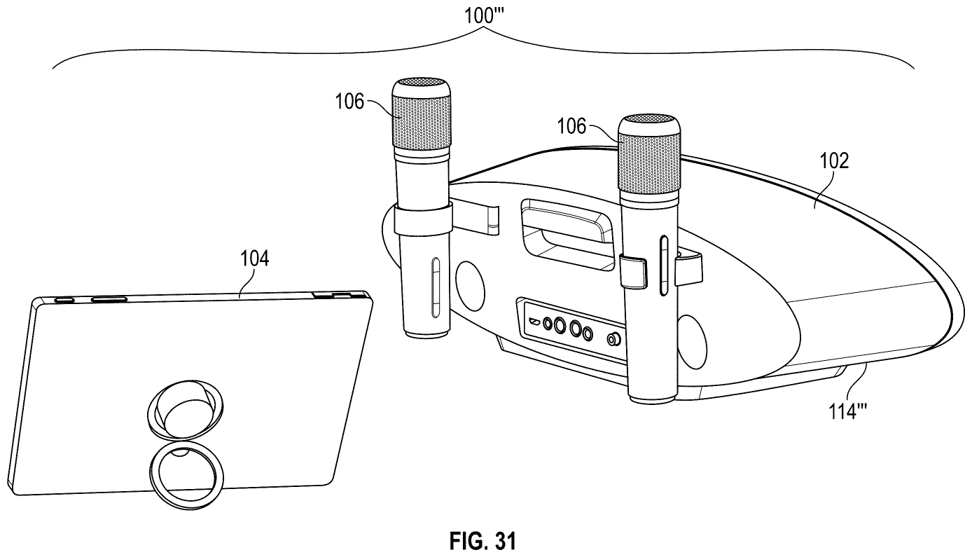

With additional reference to FIGS. 29-31, a fourth embodiment of a karaoke system 100′″ is depicted in accordance with an embodiment of the disclosure. As depicted, the housing 114′″ can generally has an elliptical profile defining a centrally located docking port 142 and a control panel 116. Other components, features, and aspects of the karaoke system 100′″ can be similar to those of the previously disclosed embodiment.

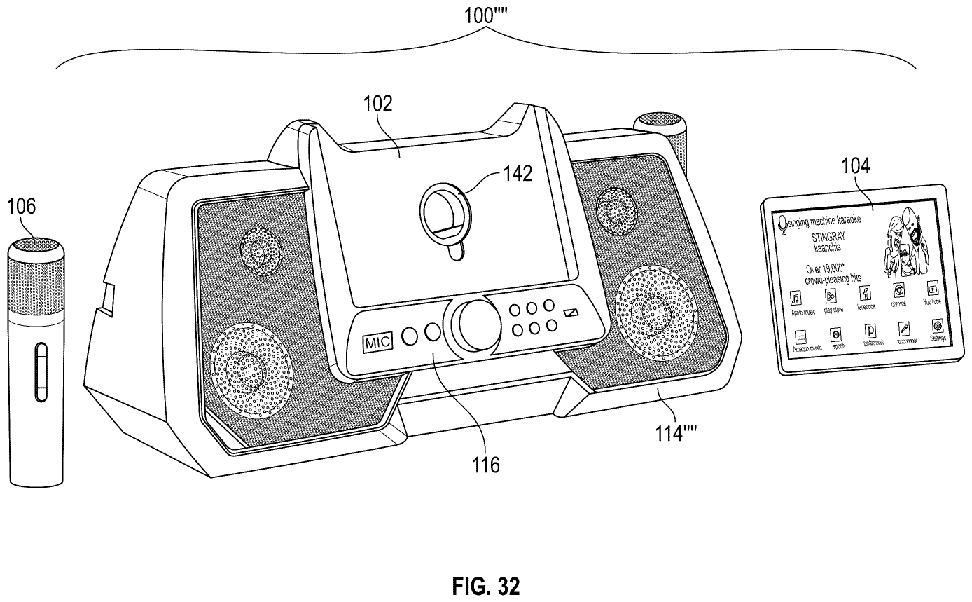

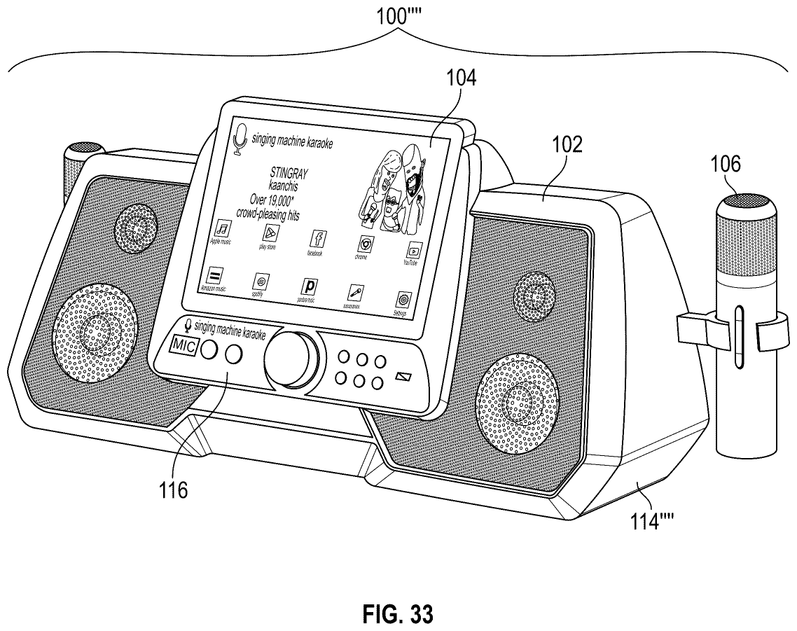

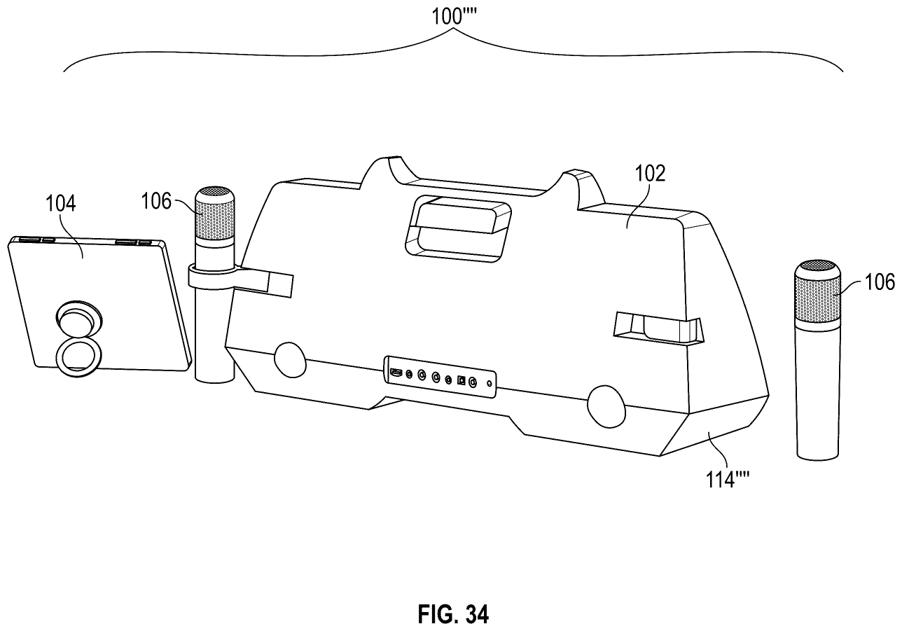

With additional reference to FIGS. 32-34, a fifth embodiment of a karaoke system 100″″ is depicted in accordance with an embodiment of the disclosure. As depicted, the housing 114″″ can define a control panel 116 and docking port 142, as well as one or more speakers 155, for example, operably coupled to the input/output module 178. Other components, features, and aspects of the karaoke system 100″″ can be similar to those of the previously disclosed embodiment.

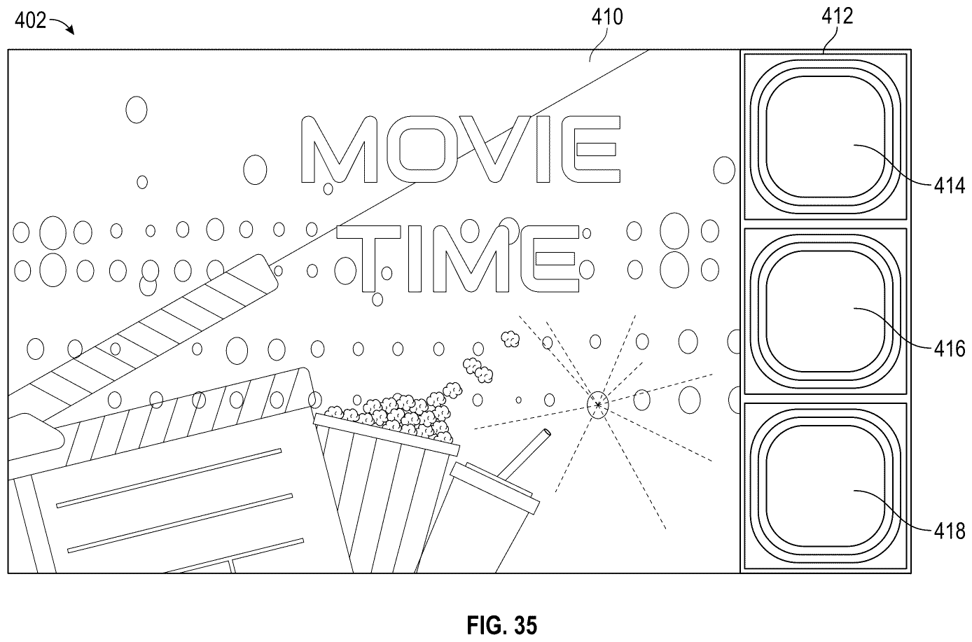

With reference to FIGS. 35-38, home screens 402, 404, 406, and 408 presentable on the touchscreen display 204 of the karaoke system 100 and the multifunctional sound bar system 200 are illustrated in accordance with embodiments of the disclosure. The processor can be configured to enable dynamic interaction with these home screens, providing users with intuitive access to system functionalities. In some embodiments, the processor can be configured to periodically cycle through the home screens 402, 404, 406, and 408 in an automated manner, allowing users to preview the available features. Alternatively, users can manually scroll through these home screens using touch gestures, such as swiping, to access desired functionalities.

As depicted in FIG. 35, the first home screen 402 can be dedicated to facilitating movie playback and related functionalities. The layout of the home screen 402 can include a primary cell 410, which occupies a prominent area of the display and is configured to present various options for selecting and viewing movies. For example, the primary cell 410 can display a carousel or grid of movie titles, thumbnails, or categories sourced from applications loaded onto the processor, such as streaming platforms or media libraries.

Adjacent to the primary cell 410, a sidebar 412 can be positioned, featuring a plurality of selectable cells 414, 416, and 418, which can contain icons or text representing additional applications or functionalities, such as media libraries, streaming services, or system settings. In some embodiments, each of the cells 410, 414, 416, and 418 can be bordered for visual separation. Alternatively, the cells can be un-bordered, providing a seamless and minimalist appearance. In some embodiments, selecting any of the sidebar cells 414, 416, or 418 can trigger the display of a corresponding home screen, such as 404, 406, or 408, thereby providing a user-friendly navigation mechanism.

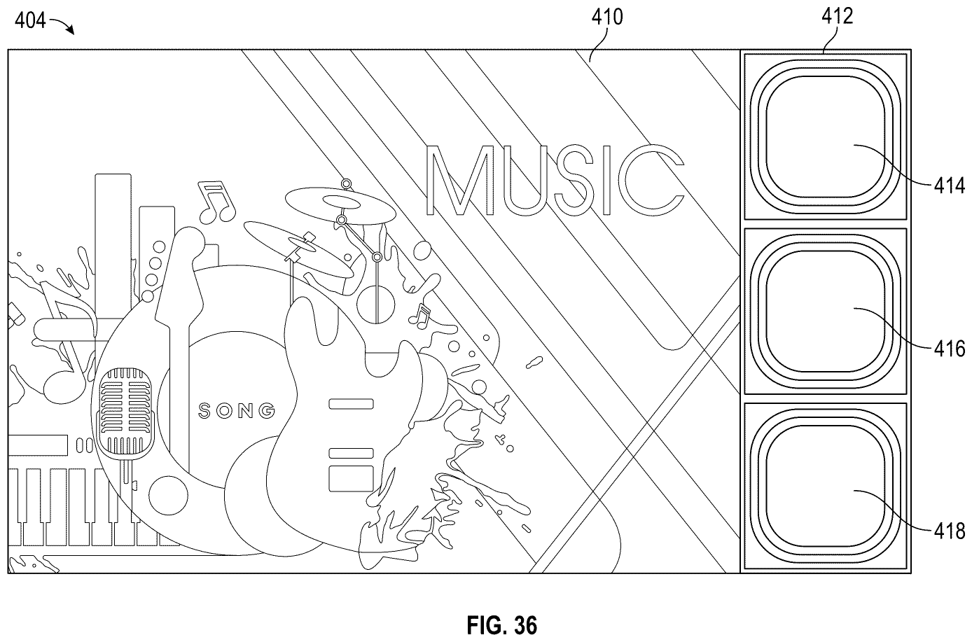

With reference to FIG. 36, the second home screen 404 can be dedicated to music playback and management. Similar to the layout of FIG. 35, the home screen 404 can include a primary cell 410, which can present a selection of music options, such as playlists, streaming services, or albums. The sidebar 412 can again include a plurality of cells 414, 416, and 418, enabling users to access other features or navigate to different home screens.

For example, the primary cell 410 on a music home screen can display a scrolling list of recommended tracks, genre categories, or recently played songs. The sidebar 412 can provide quick links to other home screens, such as movie time or karaoke, enhancing the seamless transition between functionalities.

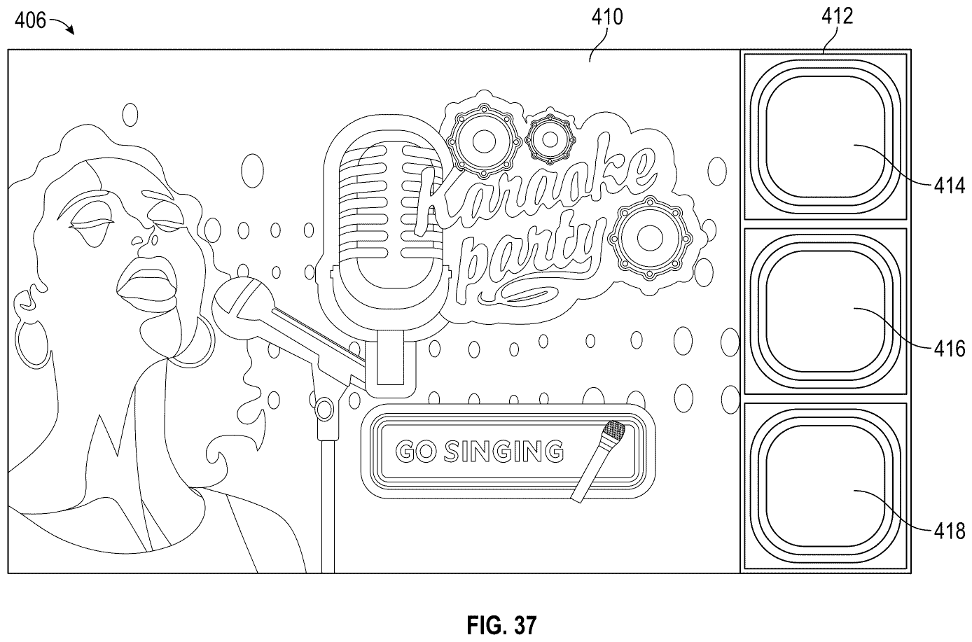

With reference to FIG. 37, the third home screen 406 can be dedicated to karaoke functionalities. The primary cell 410 on this screen can present options related to karaoke, such as song selection, lyrics display, or voice effect settings. In embodiments, the primary cell 410 can integrate features that allow users to customize karaoke sessions, such as adjusting microphone input, applying voice effects, or accessing recorded performances.

The sidebar 412 can include a plurality of cells 414, 416, and 418, allowing users to switch between the karaoke screen and other home screens, such as movie time or music. In this embodiment, the home screen 406 serves as a centralized hub for all karaoke-related interactions, providing intuitive controls and easy access to relevant features.

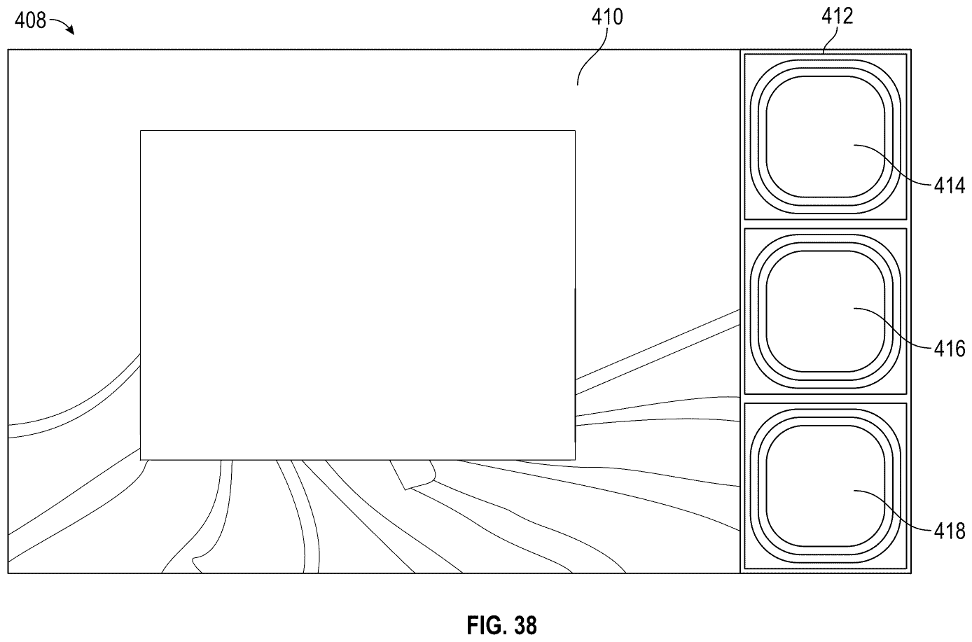

In embodiments, FIG. 38 can depict an additional home screen 408, which may be customized to display user-preferred applications, system settings, or a summary dashboard. The arrangement of the primary cell 410 and sidebar 412 can follow the same principles as the other home screens, ensuring consistency and ease of use. For example, the primary cell 410 could present a quick-access menu for frequently used apps or settings, while the sidebar 412 enables navigation to other home screens.

These home screens collectively enhance the user experience by providing organized, visually distinct interfaces tailored to different entertainment and system functionalities. The ability to cycle through or manually navigate between these screens ensures that users can efficiently access and control the desired features of both the karaoke system and the multifunctional sound bar system.

While various embodiments and examples have been described in detail herein, it should be understood that the foregoing detailed description is illustrative in nature and not restrictive. Modifications, additions, and substitutions may be made without departing from the spirit and scope of the invention as defined by the appended claims. Features from one embodiment may be combined with features from another embodiment without departing from the scope of the disclosure. The invention encompasses all such modifications and equivalents, and the scope of protection should not be limited by the specific embodiments described, but only by the claims that follow.

What is claimed is:

1. A multifunctional sound bar system comprising:
a housing;
a processor disposed within the housing and configured to coordinate operation;
a control panel disposed on the housing and comprising a plurality of tactile interface elements configured to enable user control of audio and multimedia functions;
one or more integrated speakers disposed within the housing and configured to output audio signals;
a network interface configured to establish a wireless or wired connection with a network to access multimedia content from one or more external sources; and
a touchscreen display configured to present a graphical user interface for controlling system functionality, the touchscreen display pivotally mounted to the housing and configured to transition between a stowed position and a deployed position.

2. The multifunctional sound bar system of claim 1, wherein the processor is further configured to facilitate wireless communication with one or more personal computing devices via Bluetooth.

3. The multifunctional sound bar system of claim 1, wherein the control panel further comprises buttons for adjusting microphone volume and activating audio effects including echo.

4. The multifunctional sound bar system of claim 1, wherein the touchscreen display is configured to display multimedia content including song lyrics, video playback, and system status indicators.

5. The multifunctional sound bar system of claim 1, wherein the pivotally mounted touchscreen display is configured to transition between a deployed position in which the display is angled upward and a stowed position in which the display is recessed into the housing.

6. The multifunctional sound bar system of claim 1, further comprising one or more microphone inputs configured to receive audio input signals from wired microphones.

7. The multifunctional sound bar system of claim 1, further comprising a recording module configured to record audio signals received from a connected microphone and to store the recorded signals on a USB-compatible storage device.

8. The multifunctional sound bar system of claim 1, further comprising an HDMI output configured to transmit video content to an external display device.

9. The multifunctional sound bar system of claim 1, further comprising an optical input and a coaxial input configured to receive digital audio signals from external devices.

10. The multifunctional sound bar system of claim 1, wherein the housing comprises multicolored lighting elements synchronized with audio playback and controllable via the control panel.

11. A multifunctional sound bar system comprising:
a tubular housing defining a front surface, a top surface, and opposite end surfaces;
a processor disposed within the tubular housing and configured to coordinate operation of the sound bar system;
a plurality of integrated speakers disposed within the housing and configured to emit audio through speaker grills positioned on the front surface and the opposite end surfaces of the housing;
a touchscreen display centrally disposed on the front surface of the housing, the touchscreen display configured to present a graphical user interface and to receive user input for controlling system functionality;
a control panel disposed on the top surface of the housing, the control panel comprising a plurality of tactile interface elements configured to enable user control of audio and multimedia functions; and
a network interface configured to establish a wireless or wired connection with an external network to access multimedia content.

12. The multifunctional sound bar system of claim 11, wherein the speaker grills on the front surface are configured to include integrated lighting elements that provide visual effects synchronized with audio output.

13. The multifunctional sound bar system of claim 11, further comprising a Bluetooth interface configured to enable wireless communication with external devices including microphones, smartphones, or computing devices.

14. The multifunctional sound bar system of claim 11, wherein the touchscreen display is further configured to enable selection of multimedia content, adjustment of volume levels, and access to streaming applications.

15. The multifunctional sound bar system of claim 11, further comprising a pair of microphone holders integrated with the housing, each microphone holder configured to transition between a microphone-receiving position and a stowed position substantially flush with an exterior surface of the housing.

16. The multifunctional sound bar system of claim 11, further comprising an HDMI output port configured to transmit audio and video signals from the processor to an external display.

17. The multifunctional sound bar system of claim 11, further comprising a USB port configured to receive a USB storage device for playback of stored media content or storage of recorded audio.

18. The multifunctional sound bar system of claim 11, wherein the tactile interface elements of the control panel include a rotary knob configured to control volume and select between multiple audio input modes.

19. The multifunctional sound bar system of claim 11, further comprising a handle formed in the housing and positioned behind the touchscreen display, the handle including a finger cup contoured to accommodate fingertips for manual transport.

20. The multifunctional sound bar system of claim 11, further comprising at least one microphone input configured to receive audio signals from a wired microphone for mixing with multimedia content.
